(19) United States
(12) Patent Application Publication
(10) Pub. No.: US 2024/0236843 A1
(43) Pub. Date: Jul. 11, 2024

(54) POWER SAVING MODE FOR SATELLITE ACCESS

(71) Applicant: QUALCOMM INCORPORATED, San Diego, CA (US)

(72) Inventors: Amer Catovic, San Diego, CA (US); Mungal Singh Dhanda, Slough (GB); Stephen William Edge, Escondido, CA (US); Umesh Phuyal, San Diego, CA (US); Alberto Rico Alvarino, San Diego, CA (US); Ayan Sengupta, San Diego, CA (US); Bharat Shrestha, San Diego, CA (US); Haris Zisimopoulos, London (GB)

(21) Appl. No.: 18/559,001

(22) PCT Filed: Jun. 27, 2022
(86) PCT No.: PCT/US2022/035133

§ 371 Date: Nov. 3, 2023

(30) Foreign Application Priority Data
Jul. 27, 2021 (GR) 20210100507

(51) Int. Cl. H04W 52/02; H04B 7/185

(52) U.S. Cl. CPC H04W 52/0203; H04B 7/18513

(57) ABSTRACT

Methods, systems, and devices for wireless communications are described. A network entity (e.g., a satellite) may receive control signaling indicating a discontinuous service coverage at a user equipment (UE). The network entity may transmit coverage assistance information indicating a discontinuous service coverage pattern to the UE. The UE, the network entity, or both may determine one or more parameters for a power saving mode at the UE, such as a duration of an active time, a duration of an inactive time, a duration of a keep alive time, or a combination thereof based on the coverage assistance information. In some cases, the UE may transmit an indication of the power saving mode parameters to the network entity. The network entity may transmit a control message to the UE in accordance with the parameters.

### CROSS REFERENCE

The present application is a 371 national stage filing of International PCT Application No. PCT/US2022/035133 by Catovic et al. entitled “POWER SAVING MODE FOR SATELLITE ACCESS,” filed Jun. 27, 2022; and claims priority to Greek Patent Application No. 20210100507 by Catovic et al. entitled “POWER SAVING MODE FOR SATELLITE ACCESS,” filed Jul. 27, 2021, each of which is assigned to the assignee hereof, and each of which is expressly incorporated by reference in its entirety herein.

### FIELD OF TECHNOLOGY

The following relates to wireless communications, including a power saving mode for satellite access.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support a power saving mode for satellite access. Generally, the described techniques provide for a user equipment (UE) to receive coverage assistance information from a network entity, such as a satellite, that indicates a discontinuous service coverage pattern. The UE may use the discontinuous service coverage pattern to enter a power saving mode during one or more coverage gaps of the network entity. For example, a network entity may receive control signaling indicating a discontinuous service coverage at a UE (e.g., from a core network, a radio network, or the UE). The network entity may transmit coverage assistance information indicating a discontinuous service coverage pattern to the UE. The UE, the network entity, or both may determine one or more parameters for a power saving mode at the UE, such as a duration of an active time, a duration of an inactive time, a duration of a keep alive time, or a combination thereof based on the coverage assistance information. In some cases, the UE may transmit an indication of the power saving mode parameters to the network entity. In some examples, during an active time, the UE may maintain a normal mode of operation, which may include monitoring for paging messages from the network entity. The network entity may transmit a control message to the UE during the active time. Once the active time period expires, the UE may start an inactive time period and may enter power saving mode of operation.

A method for wireless communication at a UE is described. The method may include receiving, from a network entity, control signaling including service coverage assistance information indicating a discontinuous service coverage pattern for the UE, determining, based on the control signaling, one or more parameters for a power saving mode of operation of the UE corresponding to the discontinuous service coverage pattern indicated in the service coverage assistance information, and transmitting the one or more parameters for the power saving mode of operation to the network entity.

An apparatus for wireless communication at a UE is described. The apparatus may include a processor, memory coupled with the processor, and instructions stored in the memory. The instructions may be executable by the processor to cause the apparatus to receive, from a network entity, control signaling including service coverage assistance information indicating a discontinuous service coverage pattern for the UE, determine, based on the control signaling, one or more parameters for a power saving mode of operation of the UE corresponding to the discontinuous service coverage pattern indicated in the service coverage assistance information, and transmit the one or more parameters for the power saving mode of operation to the network entity.

Another apparatus for wireless communication at a UE is described. The apparatus may include means for receiving, from a network entity, control signaling including service coverage assistance information indicating a discontinuous service coverage pattern for the UE, means for determining, based on the control signaling, one or more parameters for a power saving mode of operation of the UE corresponding to the discontinuous service coverage pattern indicated in the service coverage assistance information, and means for transmitting the one or more parameters for the power saving mode of operation to the network entity.

A non-transitory computer-readable medium storing code for wireless communication at a UE is described. The code may include instructions executable by a processor to receive, from a network entity, control signaling including service coverage assistance information indicating a discontinuous service coverage pattern for the UE, determine, based on the control signaling, one or more parameters for a power saving mode of operation of the UE corresponding to the discontinuous service coverage pattern indicated in the service coverage assistance information, and transmit the one or more parameters for the power saving mode of operation to the network entity.

In some examples of the method, apparatuses, and non-transitory computer-readable medium described herein, receiving the control signaling may include operations, features, means, or instructions for receiving one or more information elements indicating the discontinuous service coverage pattern from a set of multiple available discontinuous service coverage patterns.

In some examples of the method, apparatuses, and non-transitory computer-readable medium described herein, the one or more information elements may be included in system information on a broadcast channel of a serving radio cell.

In some examples of the method, apparatuses, and non-transitory computer-readable medium described herein, transmitting the one or more parameters may include operations, features, means, or instructions for transmitting the one or more parameters indicating an active time period, a keep alive time period, an inactive time period, or a combination thereof for the power saving mode of operation of the UE based on the discontinuous service coverage pattern.

In some examples of the method, apparatuses, and non-transitory computer-readable medium described herein, transmitting the one or more parameters may include operations, features, means, or instructions for transmitting a registration update request message including the one or more parameters during an in coverage time period corresponding to the discontinuous service coverage pattern.

Some examples of the method, apparatuses, and non-transitory computer-readable medium described herein may further include operations, features, means, or instructions for transmitting, to the network entity, a message during a keep alive time period in accordance with the one or more parameters.

Some examples of the method, apparatuses, and non-transitory computer-readable medium described herein may further include operations, features, means, or instructions for determining the discontinuous service coverage pattern based on the service coverage assistance information.

In some examples of the method, apparatuses, and non-transitory computer-readable medium described herein, the service coverage assistance information includes ephemeris data.

In some examples of the method, apparatuses, and non-transitory computer-readable medium described herein, the service coverage assistance information includes a duration of radio cell coverage and a duration of a coverage gap.

Some examples of the method, apparatuses, and non-transitory computer-readable medium described herein may further include operations, features, means, or instructions for monitoring for one or more paging messages from the network entity during an active time period indicated by the one or more parameters.

Some examples of the method, apparatuses, and non-transitory computer-readable medium described herein may further include operations, features, means, or instructions for receiving, from the network entity, one or more additional parameters indicating an active time period, a keep alive time period, an inactive time period, or a combination thereof for the power saving mode of operation of the UE based on the one or more parameters.

Some examples of the method, apparatuses, and non-transitory computer-readable medium described herein may further include operations, features, means, or instructions for starting the inactive time period upon expiry of the active time period indicated by the one or more additional parameters and entering the power saving mode of operation during the inactive time period.

Some examples of the method, apparatuses, and non-transitory computer-readable medium described herein may further include operations, features, means, or instructions for exiting the power saving mode of operation upon expiry of the inactive time period.

In some examples of the method, apparatuses, and non-transitory computer-readable medium described herein, a duration of the inactive time period may be indicated by the one or more additional parameters.

In some examples of the method, apparatuses, and non-transitory computer-readable medium described herein, a duration of the inactive time period may be determined based on one or more network access conditions of one or more applications.

In some examples of the method, apparatuses, and non-transitory computer-readable medium described herein, transmitting the one or more parameters may include operations, features, means, or instructions for transmitting an indication that the one or more parameters may be valid for a set of multiple time durations.

In some examples of the method, apparatuses, and non-transitory computer-readable medium described herein, determining the one or more parameters may include operations, features, means, or instructions for determining the one or more parameters based on one or more service conditions, one or more application conditions, or both, for network access.

In some examples of the method, apparatuses, and non-transitory computer-readable medium described herein, the UE and the network entity may be nodes in a non-terrestrial network (NTN).

A method for wireless communication at a network entity is described. The method may include receiving control signaling indicating that a UE is receiving discontinuous service coverage, determining, based on the control signaling, one or more parameters for a power saving mode of operation of the UE corresponding to a discontinuous service coverage pattern for the UE, and transmitting a control message to the UE in accordance with the one or more parameters.

An apparatus for wireless communication at a network entity is described. The apparatus may include a processor, memory coupled with the processor, and instructions stored in the memory. The instructions may be executable by the processor to cause the apparatus to receive control signaling indicating that a UE is receiving discontinuous service coverage, determine, based on the control signaling, one or more parameters for a power saving mode of operation of the UE corresponding to a discontinuous service coverage pattern for the UE, and transmit a control message to the UE in accordance with the one or more parameters.

Another apparatus for wireless communication at a network entity is described. The apparatus may include means for receiving control signaling indicating that a UE is receiving discontinuous service coverage, means for determining, based on the control signaling, one or more parameters for a power saving mode of operation of the UE corresponding to a discontinuous service coverage pattern for the UE, and means for transmitting a control message to the UE in accordance with the one or more parameters.

A non-transitory computer-readable medium storing code for wireless communication at a network entity is described. The code may include instructions executable by a processor to receive control signaling indicating that a UE is receiving discontinuous service coverage, determine, based on the control signaling, one or more parameters for a power saving mode of operation of the UE corresponding to a discontinuous service coverage pattern for the UE, and transmit a control message to the UE in accordance with the one or more parameters.

In some examples of the method, apparatuses, and non-transitory computer-readable medium described herein, determining the one or more parameters may include operations, features, means, or instructions for receiving, from the UE or a radio access network entity, an indication of the one or more parameters.

Some examples of the method, apparatuses, and non-transitory computer-readable medium described herein may further include operations, features, means, or instructions for transmitting, to the UE, one or more additional parameters indicating an active time period, a keep alive time period, an inactive time period, or a combination thereof for the power saving mode of operation of the UE based on information indicated in the control signaling.

Some examples of the method, apparatuses, and non-transitory computer-readable medium described herein may further include operations, features, means, or instructions for transmitting the control message during an active time period indicated by the one or more parameters.

In some examples of the method, apparatuses, and non-transitory computer-readable medium described herein, buffering the control message in memory during an inactive time period indicated by the one or more parameters and transmitting, from the memory, the control message during an active time period indicated by the one or more parameters subsequent to the buffering.

Some examples of the method, apparatuses, and non-transitory computer-readable medium described herein may further include operations, features, means, or instructions for receiving a message from the UE during the keep alive time period indicated by the one or more parameters.

Some examples of the method, apparatuses, and non-transitory computer-readable medium described herein may further include operations, features, means, or instructions for deregistering the UE based on expiry of the keep alive time period without receiving a message from the UE.

In some examples of the method, apparatuses, and non-transitory computer-readable medium described herein, determining the one or more parameters may include operations, features, means, or instructions for determining the one or more parameters based on one or more service conditions, one or more application conditions, or both, for network access.

In some examples of the method, apparatuses, and non-transitory computer-readable medium described herein, the UE and the network entity may be nodes in an NTN.

### BRIEF DESCRIPTION OF THE DRAWINGS

FIGS. 1 and 2 illustrate examples of wireless communications systems that support a power saving mode for satellite access in accordance with aspects of the present disclosure.

FIGS. 3A, 3B, and 4 illustrate examples of service coverage diagrams that support a power saving mode for satellite access in accordance with aspects of the present disclosure.

FIG. 5 illustrates an example of a process flow that supports a power saving mode for satellite access in accordance with aspects of the present disclosure.

FIGS. 6 and 7 show block diagrams of devices that support a power saving mode for satellite access in accordance with aspects of the present disclosure.

FIG. 8 shows a block diagram of a communications manager that supports a power saving mode for satellite access in accordance with aspects of the present disclosure.

FIG. 9 shows a diagram of a system including a device that supports a power saving mode for satellite access in accordance with aspects of the present disclosure.

FIGS. 10 and 11 show block diagrams of devices that support a power saving mode for satellite access in accordance with aspects of the present disclosure.

FIG. 12 shows a block diagram of a communications manager that supports a power saving mode for satellite access in accordance with aspects of the present disclosure.

FIG. 13 shows a diagram of a system including a device that supports a power saving mode for satellite access in accordance with aspects of the present disclosure.

FIGS. 14 through 17 show flowcharts illustrating methods that support a power saving mode for satellite access in accordance with aspects of the present disclosure.

### DETAILED DESCRIPTION

In some wireless communications systems, such as non-terrestrial network (NTN) systems, satellite operators may deploy satellite access with intentional coverage gaps. For example, if one or more services provided by the satellite operator are delay tolerant or if the satellite operator is reducing deployment and operational cost, a core network may relay information to one or more user equipments (UEs) via a satellite periodically rather than continuously. Further, UEs may use unnecessary power by camping on a network without coverage, which may be inefficient for UEs with reduced operational power, such as internet of thing (IoT) UEs. However, a UE may be unaware of a discontinuous service coverage pattern for communicating with a network entity via a satellite.

As described herein, a UE may receive control signaling including assistance information that may indicate a discontinuous service coverage pattern for the UE. The UE may determine the duration of an active time and the duration of keep alive time based on the assistance information and application or service conditions of the UE. For example, an application or service may have a condition in which the UE transmits measurement data one or more times per time period (e.g., every X number of minutes, hours, or days). The UE may select an active time and an inactive time in accordance with the application or service conditions based on the in coverage times, such that the UE complies with the one or more conditions. The UE may communicate the active time and keep alive time to a core network (e.g., using non-access stratum (NAS) protocol signaling). For example, the UE may send an indication of one or more parameters to a network entity (e.g., a satellite), such as the active time, the keep alive time, an inactive time, or a combination thereof related to the discontinuous service coverage pattern. The UE may maintain a normal mode of operation during an active time, which may involve the UE monitoring for a control message from a network entity (e.g., a satellite) and maintaining a transmit and receive mode. Once the active time ends, the UE may enter a power saving mode for an inactive time, in which the network entity may not page the UE and the UE may not transmit data. In some examples, the UE may contact the network entity at least once during a keep alive time. If the keep alive time expires, and the network entity does not receive signaling from the UE, the network entity may deregister the UE or may take additional steps to reconnect with the UE.

Aspects of the disclosure are initially described in the context of wireless communications systems. Aspects of the disclosure are further described in the context of service coverage diagrams and a process flow: Aspects of the disclosure are further illustrated by and described with reference to apparatus diagrams, system diagrams, and flowcharts that relate to power saving mode for satellite access.

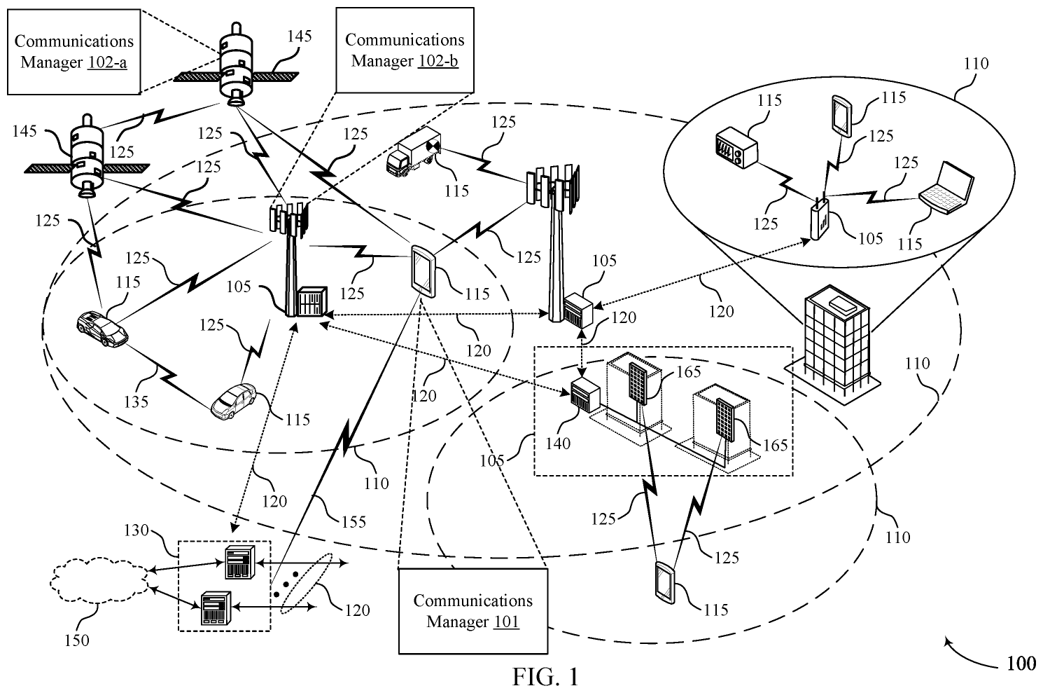

FIG. 1 illustrates an example of a wireless communications system 100 that supports a power saving mode for satellite access in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links. A UE 115 may communicate with the core network 130 through a communication link 155.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrow band IoT (NB-IOT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrow band communications), or a combination of these techniques. For example, some UEs 115 may be configured for operation using a narrow band protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5 GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 165, which may be referred to as radio heads, smart radio heads, or transmission/reception points (TRPs). Each access network transmission entity 165 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

Wireless communications system 100 may also include one or more satellites 145. Satellite 145 may communicate with base stations 105 (also referred to as gateways in NTNs) and UEs 115 (or other high altitude or terrestrial communications devices). Satellite 145 may be any suitable type of communication satellite configured to relay communications between different end nodes in a wireless communication system. Satellite 145 may be an example of a space satellite, a balloon, a dirigible, an airplane, a drone, an unmanned aerial vehicle, or the like. In some examples, the satellite 145 may be in a geosynchronous or geostationary earth orbit, a low earth orbit or a medium earth orbit. A satellite 145 may be a multi-beam satellite configured to provide service for multiple service beam coverage areas in a predefined geographical service area. The satellite 145 may be any distance away from the surface of the earth.

In some cases, a cell may be provided or established by a satellite 145 as part of an NTN. A satellite 145 may, in some cases, perform the functions of a base station 105, act as a bent-pipe satellite, or may act as a regenerative satellite, or a combination thereof. In other cases, satellite 145 may be an example of a smart satellite, or a satellite with intelligence. For example, a smart satellite may be configured to perform more functions than a regenerative satellite (e.g., may be configured to perform particular algorithms beyond those used in regenerative satellites, may be configured to be reprogrammed, etc.). A bent-pipe transponder or satellite may be configured to receive signals from ground stations and transmit those signals to different ground stations. In some cases, a bent-pipe transponder or satellite may amplify signals or shift from uplink frequencies to downlink frequencies. A regenerative transponder or satellite may be configured to relay signals like the bent-pipe transponder or satellite, but may also use on-board processing to perform other functions. Examples of these other functions may include demodulating a received signal, decoding a received signal, re-encoding a signal to be transmitted, or modulating the signal to be transmitted, or a combination thereof. For example, a bent-pipe satellite (e.g., satellite 145) may receive a signal from a base station 105 and may relay the signal to a UE 115 or base station 105, or vice-versa.

UEs 115 may communicate with satellites 145, base stations 105, or both using communication links 125. In some cases, a communications manager 101 may be included in a device to support communication of satellite location information. For example, a UE 115 may include a communications manager 101 and a satellite 145 may include a communications manager 102-a or a base station 105 may include a communications manager 102-b.

In some cases, timing adjustments or frequency adjustments may account for propagation delay or Doppler shifts that may affect communications between the UE 115 and the satellite 145. For example, communication links 125 between UE 115 and satellite 145 or between UE 115 and base station 105 via a satellite 145 may include a propagation delay or Doppler shift between a UE 115 and a satellite 145, or a propagation delay or a Doppler shift between a base station 105 and a satellite 145, or both, as well as a variation in the propagation delays due to movement of the satellite.

In some cases, a service operator, such as an operator of satellite 145, may deploy service with intentional coverage gaps. For example, a satellite 145 communicating with wireless devices that tolerate delays (e.g., for delay tolerant services) may include coverage gaps in a provided service, such as if a satellite constellation may not cover a particular location on Earth contiguously. The coverage gaps may save deployment and operational costs, may factor in design considerations (e.g., service availability, power consumption of the wireless devices, or both), or the like. In some cases, a UE 115 and a radio access network may be aware of a coverage gap schedule. However, a core network 130 may not be aware of the coverage gaps. In some cases, due to power efficiency considerations, a UE 115 may not attempt to camp or connect to a network when there is no service coverage from a satellite 145. Further, the network may not attempt to reach the UE 115 when there is no service coverage from the satellite 145 at the UE location. If the lack of coverage is considered a temporary anomaly and is dealt with as such, the UE 115 may try to recover immediately and continuously and may spend substantial energy doing so. Additionally or alternatively, the network may attempt to reach the UE 115 several times prior to giving up, which may cause inefficient resource utilization as well as latency and inefficient power usage at the UE 115.

In some cases, a UE 115 may receive coverage assistance information from a network entity that indicates a discontinuous service coverage pattern, which the UE 115 may use to enter a power saving mode during one or more coverage gaps of a satellite 145. For example, a core network 130 may determine that the core network 130 is operating in discontinuous coverage based on receiving an indication from a radio network or from a UE 115. The core network 130 or the radio network may transmit control signaling indicating the discontinuous service coverage at the UE 115 to the satellite 145. In some cases, once the core network 130 transmits the discontinuous service coverage control signaling to the satellite 145, the satellite 145 may transmit coverage assistance information indicating a discontinuous service coverage pattern to the UE 115. The UE 115 may determine one or more parameters for a power saving mode, such as a duration of an active time, a duration of an inactive time, a duration of a keep alive time, or a combination thereof based on the coverage assistance information. In some cases, the UE 115 may transmit an indication of the power saving mode parameters to a network (e.g., the core network 130) via the satellite 145. In some examples, during an active time, the UE 115 may maintain a normal mode of operation, which may include monitoring for paging messages from the satellite 145. The satellite 145 may transmit a control message to the UE 115 during the active time. Once the active time period expires, the UE 115 may start an inactive time period and may enter power saving mode of operation.

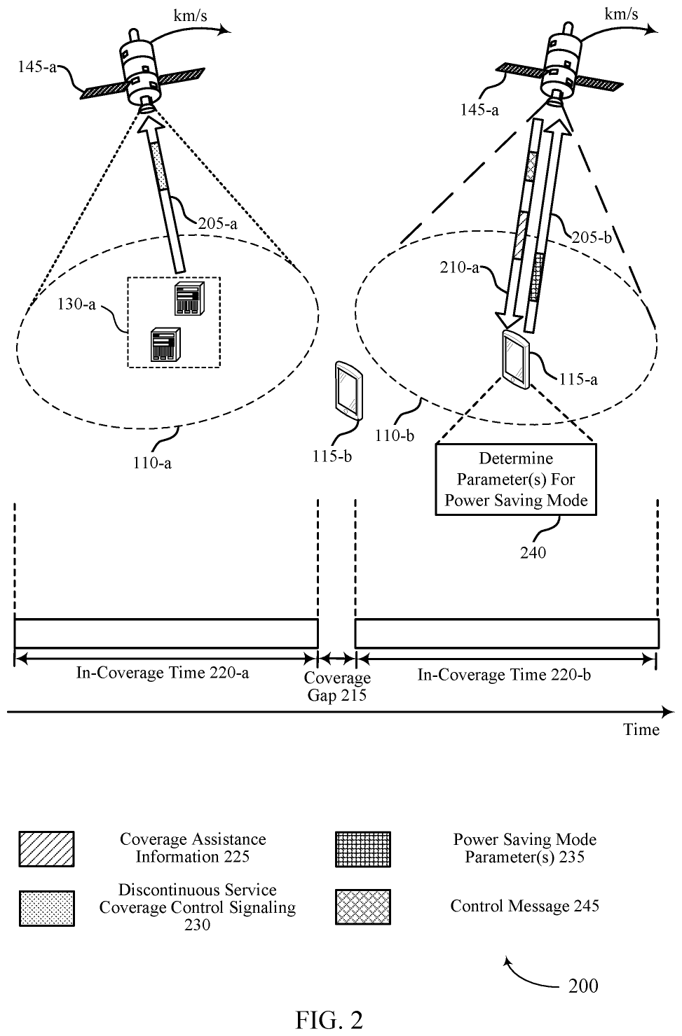

FIG. 2 illustrates an example of a wireless communications system 200 that supports a power saving mode for satellite access in accordance with aspects of the present disclosure. In some examples, the wireless communications system 200 may implement aspects of wireless communications system 100. The wireless communications system 200 may include a satellite 145-a, a UE 115-a, a UE 115-b, and a core network 130-a, which may be examples of satellites 145, UEs 115, and a core network 130 as described with reference to FIG. 1. Satellite 145-a may serve a coverage area 110-a and coverage area 110-b, which may include UE 115-a, UE 115-b, or both as satellite 145-a progresses through an orbit in examples of an NTN. That is, coverage area 110-a may be a coverage area 110 for satellite 145-a at a time prior to a time for coverage area 110-b. In some cases, satellite 145-a may be an example of a network entity.

NTNs (e.g., wireless communications system 200) may provide coverage by using high-altitude vehicles between user terminals and base stations 105 (e.g., next-generation NodeBs or giga-NodeBs, which may be referred to as a gNB, and also referred to as access stations or access gateways). A base station 105 may, for example, transmit data to a satellite 145 which may then be relayed to a user terminal or vice-versa. In some examples, a satellite 145 may perform the functions of a base station 105. Additionally or alternatively, the base station 105 may be a terrestrial-based gateway that communicates with a UE 115 via the satellite 145. For example, a base station 105 may serve UE 115-a based on sending communications between core network 130-a and satellite 145-a via an uplink communication link 205-a. Satellite 145-a may relay the communications to UE 115-a using a downlink communication link 210-a. Additionally or alternatively, satellite 145-a may be a serving satellite 145 for UE 115-a, and may perform one or more of the functionalities of a base station 105. For example, satellite 145-a may host core network 130-a and may serve UE 115-a via downlink communication link 210-a.

A user terminal may be any device capable of transmitting signals to a satellite 145. Examples of a user terminal may include a UE 115, a relay equipment configured to relay a signal between a satellite and a user terminal, or a combination thereof. NTNs may involve the use of high altitude platform stations (HAPSs) or satellites to provide coverage for terrestrial base stations 105 and UEs 115. The terms HAPS and satellite are used interchangeably herein to refer to a remote NTN device that may provide coverage to one or more other high altitude or terrestrial devices. Likewise, the terms gateway and base station 105 are used interchangeably herein to refer to a network node that serves a UE 115 and provides network access to the UE 115.

In the example of FIG. 2, satellite 145-a may relay communications between core network 130-a and UE 115-a, UE 115-b, or both. For example, core network 130-a may communicate with UE 115-a via satellite 145-a or vice-versa. In some examples, for communications originating at core network 130-a and going to UE 115-a, core network 130-a may transmit an uplink transmission to satellite 145-a via uplink communication link 205-a. If core network 130-a is terrestrial (e.g., located on earth), core network 130-a may transmit the uplink transmission while in coverage area 110-a of satellite 145-a. Coverage area 110-a may be the coverage of satellite 145-a on earth as satellite 145-a progress around an orbit. Satellite 145-a may relay the uplink transmission as a downlink transmission to UE 115-a via downlink communication link 210-a, which may be referred to as a feeder link. In some other examples, for communications originating at UE 115-a and going to core network 130-a, UE 115-a may transmit an uplink transmission to satellite 145-a via uplink communication link 205-b (e.g., a feeder link). Satellite 145-a may relay the uplink transmission as a downlink transmission to core network 130-a or may use the information in the uplink transmission. In some examples, a cell may be provided or established by satellite 145-a as part of the NTN. While the following techniques are described as communications between a terrestrial core network 130-a and UE 115-a, it should be noted that satellite 145-a may alternatively act as a core network (e.g., rather than a relay node) and any communication described as originating from core network 130-a may alternatively originate from satellite 145-a and transmitted to UE 115-a, and vice-versa.

In some cases, a service operator, such as an operator of satellite 145-a, may deploy service with intentional coverage gaps 215. For example, a satellite 145 communicating with wireless devices that tolerate delays (e.g., for delay tolerant services) may include coverage gaps 215 in a provided service, such as if a satellite constellation may not cover a particular location on Earth contiguously. A LEO satellite 145 communicating with an IoT network may tolerate delays (utility meters, sensors etc.). The coverage gaps 215 may save deployment and operational costs, may factor in design considerations (e.g., service availability, power consumption of the wireless devices, or both), or the like. UE 115-b may be in a coverage gap 215 of satellite 145-a. The coverage gap 215 may be a duration in between an in-coverage time 220 for a satellite 145 (e.g., when a wireless device is within a coverage area 110 of the satellite 145).

In some examples, an in-coverage time 220 for a stationary UE 115 and resulting coverage gap 215 may depend on the size of a coverage area 110 for a satellite 145. For example, in a 1000 km coverage area 110, an in-coverage time 220 may be approximately 2.2 minutes and a coverage gap 215 would be between 10 and 40 minutes. In some cases, a backhaul link may be available to satellite 145 and a wireless device when the coverage is available. In some cases, a UE 115 and a radio access network may be aware of a coverage gap schedule. However, a core network 130 may not be aware of the coverage gaps 215. In some cases, due to power efficiency considerations, a UE 115 may not attempt to camp or connect to a network when there is no service coverage from a satellite 145. Further, the network may not attempt to reach the UE 115 when there is no service coverage from the satellite 145 at the UE location. If the lack of coverage is considered a temporary anomaly and is dealt with as such, the UE 115 may try to recover immediately and continuously and may spend substantial energy doing so. Additionally or alternatively, the network may attempt to reach the UE 115 several times prior to giving up, which may cause inefficient resource utilization as well as latency and inefficient power usage at the UE 115.

In some cases, a UE 115 may receive coverage assistance information 225 from a network entity that indicates a discontinuous service coverage pattern, which the UE 115 may use to enter a power saving mode during one or more coverage gaps 215 of a satellite 145. For example, satellite 145-a may receive control signaling indicating UE 115-a is receiving discontinuous service coverage, which may be referred to as discontinuous service coverage control signaling 230. Satellite 145-a may receive the discontinuous service coverage control signaling 230 from core network 130-a via uplink communication link 205-a when core network 130-a is in coverage area 110-a.

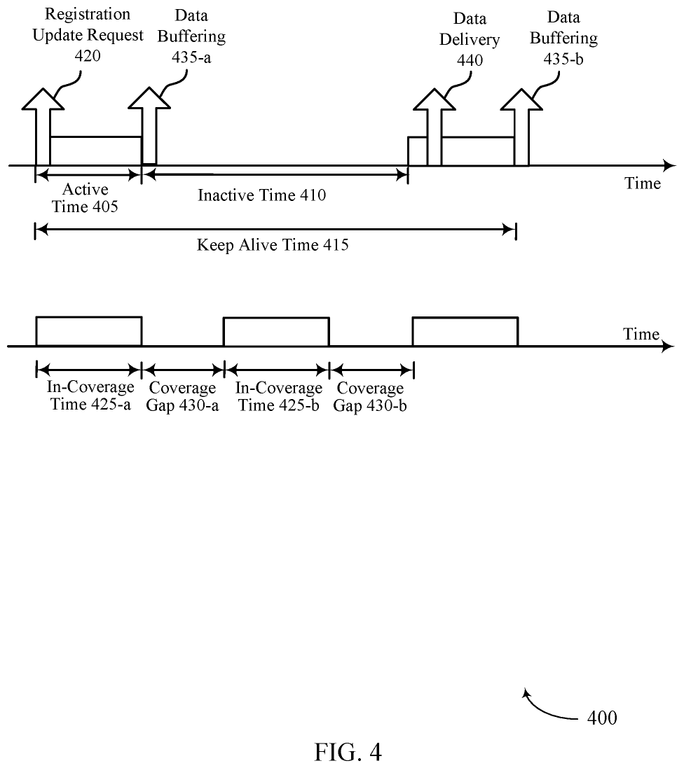

In some cases, core network 130-a may determine that core network 130-a is operating in discontinuous coverage. Core network 130-a may receive an indication from a radio network or from a UE 115 indicating the discontinuous coverage. In another example, the core network 130-a may be configured by the network operator with an indication indicating the discontinuous coverage. Core network 130-a may determine in-coverage time 220-a, in coverage time 220-b, and one or more coverage gaps 215 in a discontinuous service coverage pattern. For example, UE 115-a may relay information via a radio network regarding a power saving mode of UE 115-a. The information may include one or more power saving mode parameters 235, which may include an active time, an inactive time, a keep alive time, or a combination thereof related to the power saving mode at UE 115-a. Core network 130-a may consider UE 115-a temporarily unreachable during coverage gaps 215. Core network 130-a may determine a discontinuous service coverage pattern for multiple UEs 115, such as UE 115-a and UE 115-b. UE 115-b may be located within a coverage gap 215, and may therefore be considered temporarily unreachable by core network 130-a. In some examples, core network 130-a may buffer data or control signaling during a coverage gap 215 and may deliver the data or control signaling during in-coverage times 220, which is described in further detail with respect to FIG. 4.

In some cases, once core network 130-a transmits the discontinuous service coverage control signaling 230 to satellite 145-a during in-coverage time 220-a, satellite 145-a may transmit the coverage assistance information 225 to UE 115-a during in coverage time 220-b. The coverage assistance information 225 may include a discontinuous service coverage pattern, such as an in-coverage time 220 and coverage gap 215 pattern. The coverage assistance information 225 may be ephemeris data broadcast by a network or explicit information about the in-coverage time 220 and coverage gap 215 that may broadcast in a satellite cell (e.g., from satellite 145-a). At 240, UE 115-a may determine one or more parameters for a power saving mode, such as a duration of an active time, a duration of an inactive time, a duration of a keep alive time, or a combination thereof at UE 115-a. UE 115-a may determine the power saving mode parameters 235 based on the coverage assistance information 225 and one or more application conditions, service conditions, or both at UE 115-a.

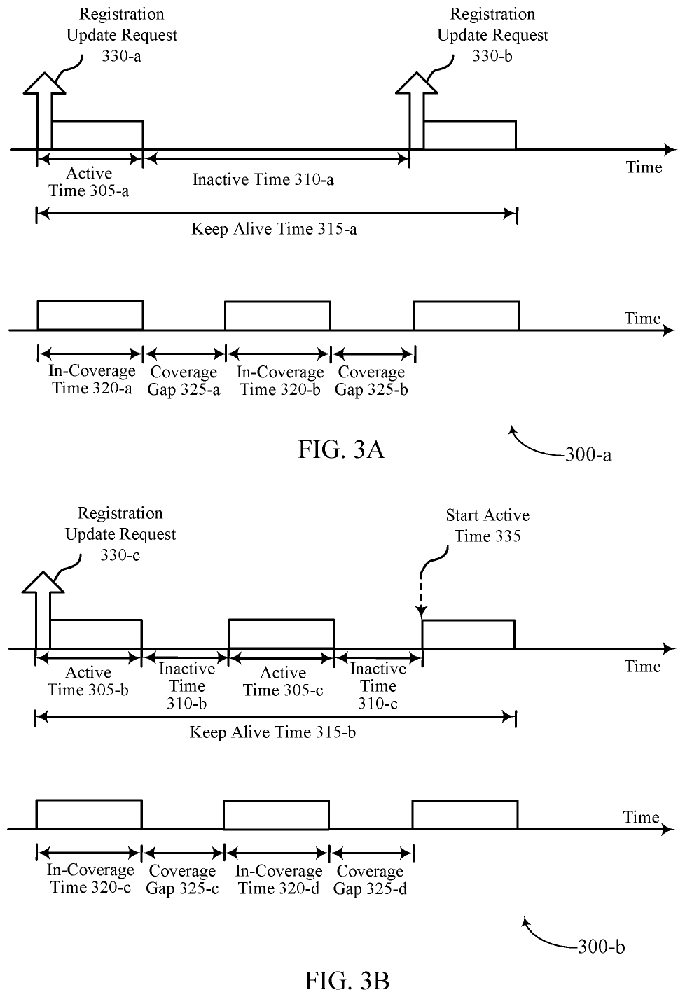

In some cases, UE 115-a may transmit an indication of the power saving mode parameters 235 to the network (e.g., core network 130-a) via satellite 145-a and uplink communication link 205-b. For example, UE 115-a may communicate the active time and the keep alive time to the network. In some examples, UE 115-a may perform a tracking area update (TAU) or registration update procedure to trigger a new active time and become reachable. UE 115-a may transmit a registration update request message during the registration update procedure, which may include the power saving mode parameters 235. In some cases, UE 115-a may request multiple active times in a registration update request, such that the power saving mode parameters 235 may be relevant for multiple active times. UE 115-a may include a direct mapping between the in-coverage time 220 and an active time, a coverage gap 215 and an inactive time, or both. For example, the duration of the active time may be the same as a duration of the in-coverage time 220 and the duration of the inactive time may at least span a coverage gap 215. In some other examples, the duration of the active time may be less than the duration of the in-coverage time 220. The duration of the active time may occur periodically relative to the in-coverage time 220 (e.g., once every X number of in-coverage times 220). In some cases, the power saving mode parameters 235 may include an active time during an in-coverage time 220, an inactive time during a coverage gap 215, and a keep alive time that may span both one or more in-coverage times 220 and one or more coverage gaps 215, which is described in further detail with respect to FIGS. 3A and 3B.

In some examples, during an active time, UE 115-a may maintain a normal mode of operation, which may include monitoring for paging messages from satellite 145-a. For example, satellite 145-a may send a control message 245 to UE 115-a during the active time. Once the active time period expires, UE 115-a may start an inactive time period and may enter power saving mode of operation, which is described in further detail with respect to FIG. 3A. The power saving mode of operation may be a reduced power state without transmitting and receiving at UE 115-a (e.g., UE 115-a may shut down the access stratum layer outside of in-coverage time 220-a). In some cases, UE 115-a may contact a network entity (e.g., satellite 145-a) at least once during the keep alive time. For example, UE 115-a may send a message to satellite 145-a via uplink communication link 205-b prior to expiration of a keep alive time. In some examples, if the keep alive time expires and the network entity does not hear from UE 115-a, the network entity may attempt to re-establish contact with UE 115-a. In some other examples, the network entity may deregister UE 115-a if the network entity does not hear from UE 115-a during the keep alive time or if re-establishing the connection is unsuccessful.

FIGS. 3A and 3B illustrate examples of service coverage diagrams 300 that support a power saving mode for satellite access in accordance with aspects of the present disclosure. In some examples, service coverage diagram 300-a and service coverage diagram 300-b may implement aspects of wireless communications system 100 and wireless communications system 200. For example, a UE 115, a core network 130, and one or more satellites 145 may implement service coverage diagram 300-a based on operating according to a power saving mode based on a discontinuous service coverage pattern at the UE 115 on a per active time basis. In some other examples, a UE 115, a core network 130, and one or more satellites 145 may implement service coverage diagram 300-b based on operating according to a power saving mode based on a discontinuous service coverage pattern at the UE 115 for multiple active times. The discontinuous service coverage pattern may be the cycle of an in-coverage time 320 relative to a coverage gap 325. The coverage assistance information may explicitly or implicitly indicate the cycle, the in-coverage time 320, the coverage gap 325, or any combination thereof.

In some cases, a network entity, such as a satellite 145 as described with reference to FIGS. 1 and 2, may receive control signaling indicating a UE 115 is to receive discontinuous service coverage. The network entity may transmit coverage assistance information indicating a discontinuous service coverage pattern for the discontinuous service coverage at the UE 115. For example, the UE 115 may be an example of a reduced power UE (e.g., related to IoT applications, such as a sensor or meter with reduced capability), and may not maintain a continuous connection with a network. The UE 115 may determine one or more parameters, such as an active time 305, an inactive time 310, a keep alive time 315, or a combination thereof from the assistance information. For example, the assistance information may include a direct indication of the parameters. In some other examples, the UE 115 may calculate the one or more parameters. The parameters may relate to the in-coverage time 320 and the out of coverage time, such as the coverage gap 325. For example, the parameters may be of a same duration (e.g., the active time 305 may be the same duration as the in-coverage time 320 and the inactive time 310 may be the same duration as the coverage gap 325). In some other examples, the active time 305 may a subset of or an entirety of the in-coverage time 320. The inactive time 310 may be at least the duration of the coverage gap 325 (e.g., may be greater than the duration of the coverage gap 325). In some cases, the keep alive time 315 may be much greater than the duration of the in-coverage time 320 and the coverage gap 325 combined. For example, the active time 305 may be the duration of an in-coverage time 320 of a UE 115. In some other examples, the active time 305 may be different than the duration of the in-coverage time 320, such as less than the in-coverage time 320. Similarly, the inactive time 310 may be at least the duration of a coverage gap 325.

For example, the assistance information may include an indication of an in-coverage time 320 for the UE 115. The in-coverage time 320 may be the duration in which the UE 115 is within a coverage area of the network entity. Additionally or alternatively, the assistance information may include an indication of a coverage gap 325, which may be the duration in which the UE 115 is outside the coverage area of the network entity. For example, the assistance information may indicate an in-coverage time 320 of 2 minutes and a coverage gap duration of 30 minutes. The UE 115 may use the assistance information and an application condition (e.g., 1 upload every 60 minutes), to calculate an active time 305 of 2 minutes, a keep alive time 315 of 1 day, and an inactive time 310.

In some cases, as illustrated in FIG. 3A, a UE 115 may communicate the parameters, such as active time 305-a, inactive time 310-a, keep alive time 315-a, or a combination thereof, to a network entity using a registration update request 330 in a TAU procedure or registration update procedure at the start of each active time 305. In some cases, the UE 115 may transmit the parameters to the network entity at the beginning of each in-coverage time 320 for an active time 305. For example, the UE 115 may transmit registration update request 330-a at the beginning of active time 305-a prior to in-coverage time 320-a, the UE 115 may enter inactive time 310-a during coverage gap 325-a, in-coverage time 320-b, and coverage gap 325-b. Once the inactive time 310-a expires, the UE 115 may enter another active time 305, which may include sending registration update request 330-b with new parameters (e.g., a new active time 305, a new inactive time 310, a new keep alive time 315, or a combination thereof). During an inactive time 310, such as inactive time 310-a, the UE 115 may shut down, and the network entity may consider the UE 115 temporarily unreachable.

In some cases, as illustrated in FIG. 3B, a UE 115 may communicate the parameters, such as active time 305-b, active time 305-c, inactive time 310-b, inactive time 310-c, keep alive time 315-b, or a combination thereof, to a network entity using a registration update request 330 in a TAU procedure or registration update procedure for multiple active times 305. In some cases, the UE 115 may transmit the parameters to the network entity at the beginning of an in-coverage time 320 for an active time 305. For example, the UE 115 may transmit registration update request 330-c at the beginning of active time 305-b prior to in-coverage time 320-c. In some cases, the UE 115 may transmit multiple active times 305, multiple inactive times 310, multiple keep alive times 315, or a combination thereof. In some other cases, the UE 115 may transmit a single active time 305, inactive time 310, keep alive time 315, or a combination thereof that may be relevant for multiple periods. That is, active time 305-b may have a same value as active time 305-c or may have a different value than active time 305-c. Similarly, inactive time 310-b may have a same value as inactive time 310-c or may have a different value than inactive time 310-c. UE 115-a may enter inactive time 310-c during coverage gap 325-c, active time 305-c during in-coverage time 320-d, and inactive time 310-c during coverage gap 325-d. Once inactive time 310-c expires, the UE 115 may start another active time at 335 without sending another registration update request 330. Instead, the UE 115 may reuse parameters from registration update request 330-c.

During an inactive time 310, such as inactive time 310-a through inactive time 310-c, the UE 115 may shut down, and the network entity may consider the UE 115 temporarily unreachable. During an active time 305, such as active time 305-a through active time 305-c, the network entity may send information, such as a control message or data, to the UE 115, the UE 115 may send information to the network entity, or both. For example, the UE 115 may send a message to the UE 115 during an active time 305, the message related to the keep alive time 315 to prevent the network entity from deregistering the UE 115.

FIG. 4 illustrates an example of a service coverage diagram 400 that supports a power saving mode for satellite access in accordance with aspects of the present disclosure. In some examples, service coverage diagram 400 may implement aspects of wireless communications system 100, wireless communications system 200, and service coverage diagrams 300. For example, a UE 115, a core network 130, and one or more satellites 145 may implement service coverage diagram 400 based on operating according to a power saving mode based on a discontinuous service coverage pattern at the UE 115. A network entity, such as a satellite 145, core network 130, or both as described with reference to FIGS. 1 and 2, may communicate with a UE 115 during an active time 405 and may buffer data during an inactive time 410 based on the discontinuous service coverage pattern.

In some cases, a network entity may receive control signaling indicating a UE 115 is to receive discontinuous service coverage. The network entity may transmit coverage assistance information indicating a discontinuous service coverage pattern for the discontinuous service coverage at the UE 115. For example, the UE 115 may be an example of a reduced power UE (e.g., related to IoT applications, such as a sensor or meter with reduced capability), and may not maintain a continuous connection with a network. The UE 115 may determine one or more parameters, such as an active time 405, an inactive time 410, a keep alive time 415, or a combination thereof from the assistance information. For example, the assistance information may include a direct indication of the parameters. In some other examples, the UE 115 may calculate the one or more parameters.

In some cases, a UE 115 may communicate the parameters, such as an active time 405, an inactive time 410, a keep alive time 415, or a combination thereof, to a network entity using a registration update request 420 in a TAU procedure or registration update procedure at the start of an active time 405, as described with reference to FIGS. 3A and 3B. In some cases, the UE 115 may transmit the parameters to the network entity at the beginning of an in-coverage time 425, such as in-coverage time 425-a, for an active time 405. The UE 115 may enter an inactive time 410 during one or more coverage gaps 430, one or more in-coverage times 425, or both. For example, the UE 115 may be in a power save mode during coverage gap 430-a, in-coverage time 425-b, and coverage gap 430-b. While the UE 115 is in the power save mode during the inactive time 410, the network entity may perform a data buffering operation 435, such as data buffering operation 435-a.

Once the inactive time 410 expires, the UE 115 may enter another active time 405, and the network entity may perform a data deliver operation 440 based on buffering the data during the inactive time 410. For example, the network entity may send data during the active time 405 that was buffered during the inactive time 410, the coverage gap 430, or both. In some cases, the network entity may deliver control signaling, data, or both during the data deliver operation 440. For example, the network entity may deliver a control message to the UE 115. After the active time 405, the network entity may continue to buffer additional data. For example, the network entity may perform data buffering operation 435-b after an active time 405.

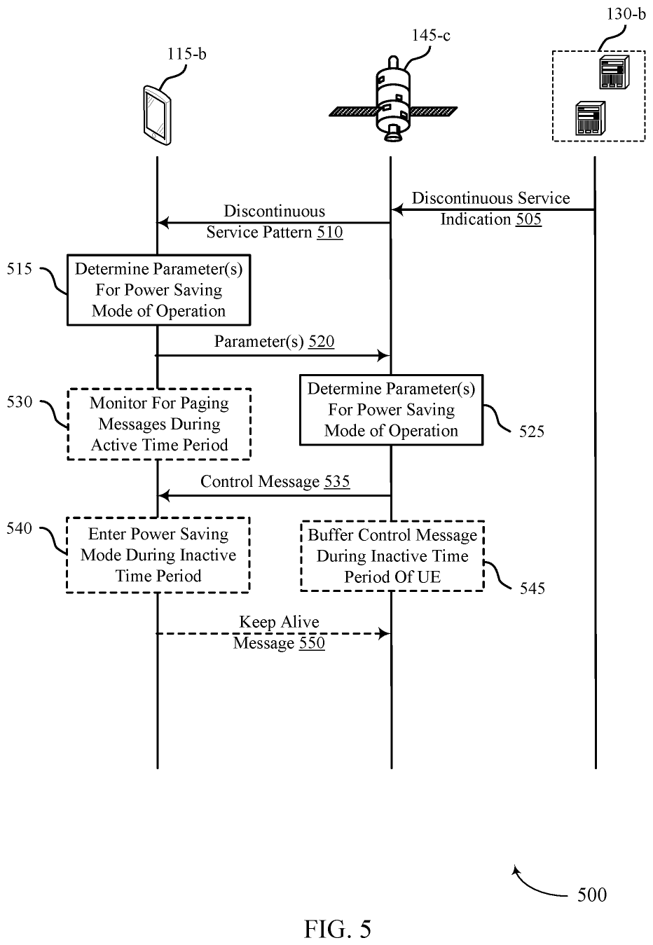

FIG. 5 illustrates an example of a process flow 500 that supports a power saving mode for satellite access in accordance with aspects of the present disclosure. In some examples, process flow 500 may implement aspects of wireless communications system 100, wireless communications system 200, service coverage diagrams 300, and service coverage diagram 400. The process flow 500 may illustrate an example of a network entity, such as a satellite 145-c, which may be an example of a satellite 145 as described with reference to FIG. 1, transmitting a discontinuous service pattern to a UE 115 (e.g., UE 115-b) for a power saving mode of operation at the UE 115. Alternative examples of the following may be implemented, where some processes are performed in a different order than described or are not performed. In some cases, processes may include additional features not mentioned below, or further processes may be added.

In some examples, satellite 145-c may communicate with core network 130-b, which may be an example of a core network 130 as described with reference to FIG. 1. In some cases, satellite 145-c may operate as a relay to convey information between a network and a UE 115, such as core network 130-b and UE 115-b. In some other cases, satellite 145-c may operate as an independent cell and may directly communicate the information with UE 115-b. In some examples, UE 115-b and satellite 145-c may be nodes in a non-terrestrial network. In some examples, the satellite 145-c may be considered part of the core network 130-b. In some examples, operations described as being performed by the satellite 145-c may instead be performed by the core network 130-b,

At 505, a network entity, which may be satellite 145-c, may receive control signaling indicating that UE 115-b is receiving discontinuous service coverage. In some examples, satellite 145-c may receive the control signaling from core network 130-b. In some other examples, satellite 145-c may receive the control signaling from another network entity, such as a UE 115 (e.g., directly from UE 115-b), a base station 105, a radio network, a network management system or the like.

At 510, UE 115-b may receive control signaling including service coverage assistance information indicating a discontinuous service coverage pattern for UE 115-b from satellite 145-c (e.g., the network entity). For example, UE 115-b may receive one or more information elements indicating the discontinuous service coverage pattern from a list of available discontinuous service coverage patterns. The information elements may be included in the control signaling and may span a number of time-frequency resources. For example, the core network 130-b may transmit a control message indicating a set of discontinuous service coverage patterns where each pattern has a different in-coverage duration and a coverage gap duration. Each discontinuous service coverage pattern may also have a same or different periodicity. In other examples, the UE 115-b may be preconfigured with the set of discontinuous service coverage patterns. The control signaling may include service coverage assistance information indicating one of the discontinuous service coverage patterns from the set.

The one or more information elements may be included in system information on a broadcast channel of a serving radio cell. In some cases, UE 115-b may determine the discontinuous service coverage pattern based on the service coverage assistance information. The service coverage assistance information may include or indicate ephemeris data, a duration of radio cell coverage, a duration of a coverage gap, or a combination thereof. In some cases, UE 115-b may use ephemeris data to determine the discontinuous service coverage pattern, thus the control signaling may implicitly indicate the discontinuous service coverage pattern (e.g., based on an expected in-coverage time and coverage gap). In some other cases, the assistance information may directly (e.g., explicitly) indicate an in-coverage time and coverage gap, rather than having the UE infer the durations from the ephemeris data.

At 515, UE 115-b may determine one or more parameters for a power saving mode of operation of UE 115-b. For example, UE 115-b may determine the parameters based on the control signaling from 510. The power saving mode of operation may be based on the discontinuous service coverage pattern indicated in the service coverage assistance information. For example, UE 115-b may enter the power saving mode of operation during an inactive time, which may be during a coverage gap or one or more in-coverage times, which may be indicated in the service coverage assistance information. In some cases, UE 115-b may determine one or more additional parameters indicating an active time period, a keep alive time period, an inactive time period, or a combination thereof from satellite 145-c. In some other cases, UE 115-b may determine the one or more parameters based on one or more service conditions, one or more application conditions, or both, for network access.

At 520, UE 115-b may transmit the one or more parameters for the power saving mode of operation to a core network entity, such as Access and Mobility Management function (AMF) via satellite 145-c. For example, UE 115-b may transmit the one or more parameters indicating an active time period, a keep alive time period, an inactive time period, or a combination thereof for the power saving mode of operation of UE 115-b based on the discontinuous service coverage pattern. In some cases, UE 115-b may transmit a registration update request message as part of a registration update procedure or a TAU procedure. The registration update request message may include the one or more parameters. UE 115-b may send the registration update request during an in coverage time period of the discontinuous service coverage pattern. In some cases, UE 115-b may transmit an indication that the one or more parameters are valid for multiple time durations. UE 115-b may transmit multiple sets of parameters for the multiple time durations, may indicate that the parameters are to be repeated for the time durations, or both.

At 525, an AMF may determine one or more parameters for a power saving mode of operation at UE 115-b based on the control signaling. In some cases, the AMF may receive an indication of the parameters from UE 115-b or a radio access network entity. For example, UE 115-b may determine the parameters based on the assistance information and may report the parameters to the AMF via satellite 145-c (e.g., directly or via a radio access network entity). This report of the parameters to the AMF represents a request to use the parameters for power saving mode. The AMF may accept the request to use the power saving mode and provide to UE 115-b the same one or more parameters provided by UE 115-b. Additionally or alternatively, the AMF may accept the request to use the power saving mode and provide a different value for the parameters to UE 115-b from the values provide by UE 115-b. Additionally or alternatively, the AMF may not accept the request to use PSM and not provide parameters to UE 115-b.

At 530, UE 115-b may monitor for one or more paging messages from the network entity, or satellite 145-c, during an active time period indicated by the one or more parameters. That is, UE 115-b may maintain a normal mode of operation during an active period.

At 535, satellite 145-c may transmit a control message or data to UE 115-b in accordance with the one or more parameters. In some cases, satellite 145-c may transmit the control message or data during an active time period indicated by the one or more parameters.

At 540, UE 115-b may enter a power saving mode of operation during an inactive time period. For example, UE 115-b may start an inactive time period upon expiry of an active time period indicated by the parameters. UE 115-b may enter the power saving mode of operation during the inactive time period. In some cases, UE 115-b may exit the power saving mode of operation upon expiry of the inactive time period. In some examples, a duration of the inactive time period may be indicated by the one or more additional parameters, determined based on one or more network access conditions of one or more applications, or both.

At 545, satellite 145-c may buffer a control message or data in memory during an inactive time period indicated by the one or more parameters. Satellite 145-c may transmit the control message or data from the memory during an active time period indicated by the one or more parameters subsequent to the buffering.

At 550, UE 115-b may transmit a message to satellite 145-c during a keep alive time period in accordance with the one or more parameters. If satellite 145-c does not receive the message, satellite 145-c may attempt to re-establish communications with UE 115-b, or may deregister UE 115-b based on expiry of the keep alive time period.

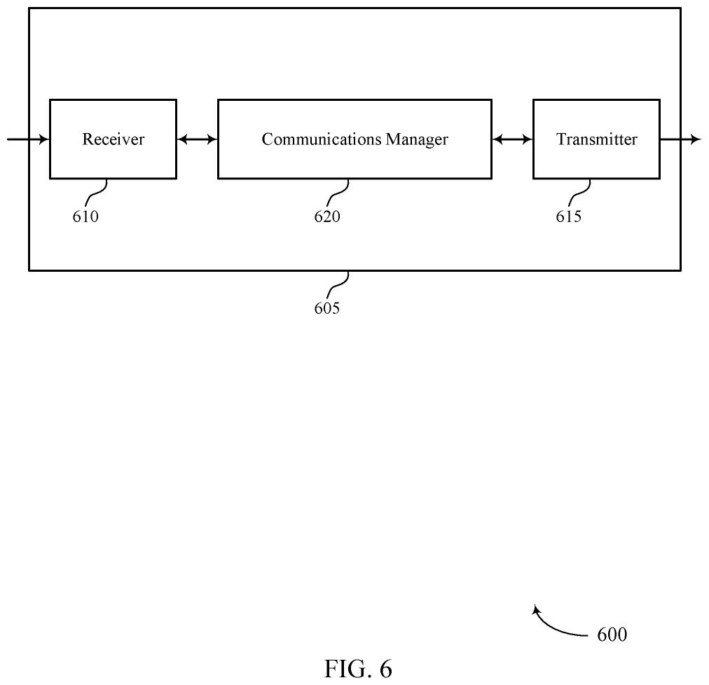

FIG. 6 shows a block diagram 600 of a device 605 that supports a power saving mode for satellite access in accordance with aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to power saving mode for satellite access). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to power saving mode for satellite access). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of power saving mode for satellite access as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a UE in accordance with examples as disclosed herein. For example, the communications manager 620 may be configured as or otherwise support a means for receiving, from a network entity, control signaling including service coverage assistance information indicating a discontinuous service coverage pattern for the UE. The communications manager 620 may be configured as or otherwise support a means for determining, based on the control signaling, one or more parameters for a power saving mode of operation of the UE corresponding to the discontinuous service coverage pattern indicated in the service coverage assistance information. The communications manager 620 may be configured as or otherwise support a means for transmitting the one or more parameters for the power saving mode of operation to the network entity.

By including or configuring the communications manager 620 in accordance with examples as described herein, the device 605 (e.g., a processor controlling or otherwise coupled to the receiver 610, the transmitter 615, the communications manager 620, or a combination thereof) may support techniques for a UE to receive coverage assistance information from a network entity, such as a satellite, that indicates a discontinuous service coverage pattern. The UE may use the discontinuous service coverage pattern to enter a power saving mode during one or more coverage gaps of the network entity, which may cause reduced processing, reduced power consumption, more efficient utilization of communication resources, and the like.

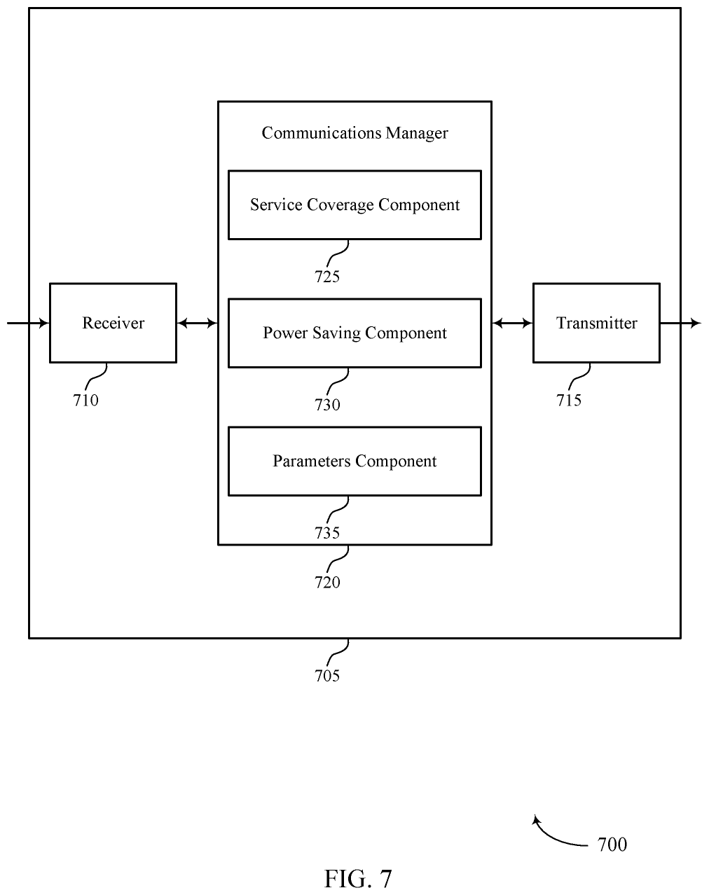

FIG. 7 shows a block diagram 700 of a device 705 that supports a power saving mode for satellite access in accordance with aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to power saving mode for satellite access). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to power saving mode for satellite access). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of power saving mode for satellite access as described herein. For example, the communications manager 720 may include a service coverage component 725, a power saving component 730, a parameters component 735, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communication at a UE in accordance with examples as disclosed herein. The service coverage component 725 may be configured as or otherwise support a means for receiving, from a network entity, control signaling including service coverage assistance information indicating a discontinuous service coverage pattern for the UE. The power saving component 730 may be configured as or otherwise support a means for determining, based on the control signaling, one or more parameters for a power saving mode of operation of the UE corresponding to the discontinuous service coverage pattern indicated in the service coverage assistance information. The parameters component 735 may be configured as or otherwise support a means for transmitting the one or more parameters for the power saving mode of operation to the network entity.

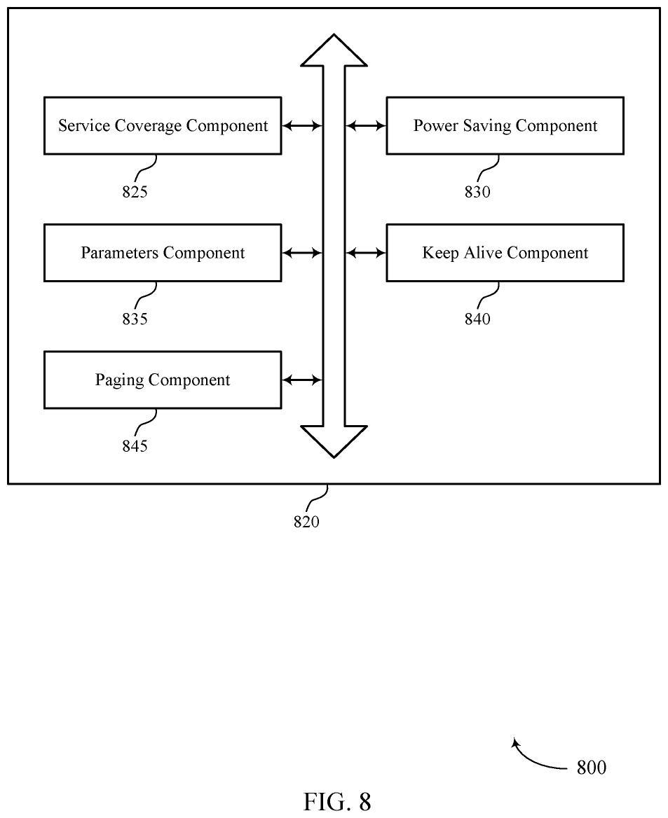

FIG. 8 shows a block diagram 800 of a communications manager 820 that supports a power saving mode for satellite access in accordance with aspects of the present disclosure. The communications manager 820 may be an example of aspects of a communications manager 620, a communications manager 720, or both, as described herein. The communications manager 820, or various components thereof, may be an example of means for performing various aspects of power saving mode for satellite access as described herein. For example, the communications manager 820 may include a service coverage component 825, a power saving component 830, a parameters component 835, a keep alive component 840, a paging component 845, or any combination thereof. Each of these components may communicate, directly or indirectly, with one another (e.g., via one or more buses).

The communications manager 820 may support wireless communication at a UE in accordance with examples as disclosed herein. The service coverage component 825 may be configured as or otherwise support a means for receiving, from a network entity, control signaling including service coverage assistance information indicating a discontinuous service coverage pattern for the UE. The power saving component 830 may be configured as or otherwise support a means for determining, based on the control signaling, one or more parameters for a power saving mode of operation of the UE corresponding to the discontinuous service coverage pattern indicated in the service coverage assistance information. The parameters component 835 may be configured as or otherwise support a means for transmitting the one or more parameters for the power saving mode of operation to the network entity.

In some examples, to support receiving the control signaling, the service coverage component 825 may be configured as or otherwise support a means for receiving one or more information elements indicating the discontinuous service coverage pattern from a set of multiple available discontinuous service coverage patterns.

In some examples, the one or more information elements are included in system information on a broadcast channel of a serving radio cell.

In some examples, to support transmitting the one or more parameters, the parameters component 835 may be configured as or otherwise support a means for transmitting the one or more parameters indicating an active time period, a keep alive time period, an inactive time period, or a combination thereof for the power saving mode of operation of the UE based on the discontinuous service coverage pattern.

In some examples, to support transmitting the one or more parameters, the parameters component 835 may be configured as or otherwise support a means for transmitting a registration update request message including the one or more parameters during an in coverage time period corresponding to the discontinuous service coverage pattern.

In some examples, the keep alive component 840 may be configured as or otherwise support a means for transmitting, to the network entity, a message during a keep alive time period in accordance with the one or more parameters.

In some examples, the service coverage component 825 may be configured as or otherwise support a means for determining the discontinuous service coverage pattern based on the service coverage assistance information. In some examples, the service coverage assistance information includes ephemeris data. In some examples, the service coverage assistance information includes a duration of radio cell coverage and a duration of a coverage gap.

In some examples, the paging component 845 may be configured as or otherwise support a means for monitoring for one or more paging messages from the network entity during an active time period indicated by the one or more parameters.

In some examples, the parameters component 835 may be configured as or otherwise support a means for receiving, from the network entity, one or more additional parameters indicating an active time period, a keep alive time period, an inactive time period, or a combination thereof for the power saving mode of operation of the UE based on the one or more parameters.

In some examples, the power saving component 830 may be configured as or otherwise support a means for starting the inactive time period upon expiry of the active time period indicated by the one or more additional parameters. In some examples, the power saving component 830 may be configured as or otherwise support a means for entering the power saving mode of operation during the inactive time period.

In some examples, the power saving component 830 may be configured as or otherwise support a means for exiting the power saving mode of operation upon expiry of the inactive time period. In some examples, a duration of the inactive time period is indicated by the one or more additional parameters. In some examples, a duration of the inactive time period is determined based on one or more network access conditions of one or more applications.

In some examples, to support transmitting the one or more parameters, the parameters component 835 may be configured as or otherwise support a means for transmitting an indication that the one or more parameters are valid for a set of multiple time durations.

In some examples, to support determining the one or more parameters, the parameters component 835 may be configured as or otherwise support a means for determining the one or more parameters based on one or more service conditions, one or more application conditions, or both, for network access.

In some examples, the UE and the network entity are nodes in an NTN.

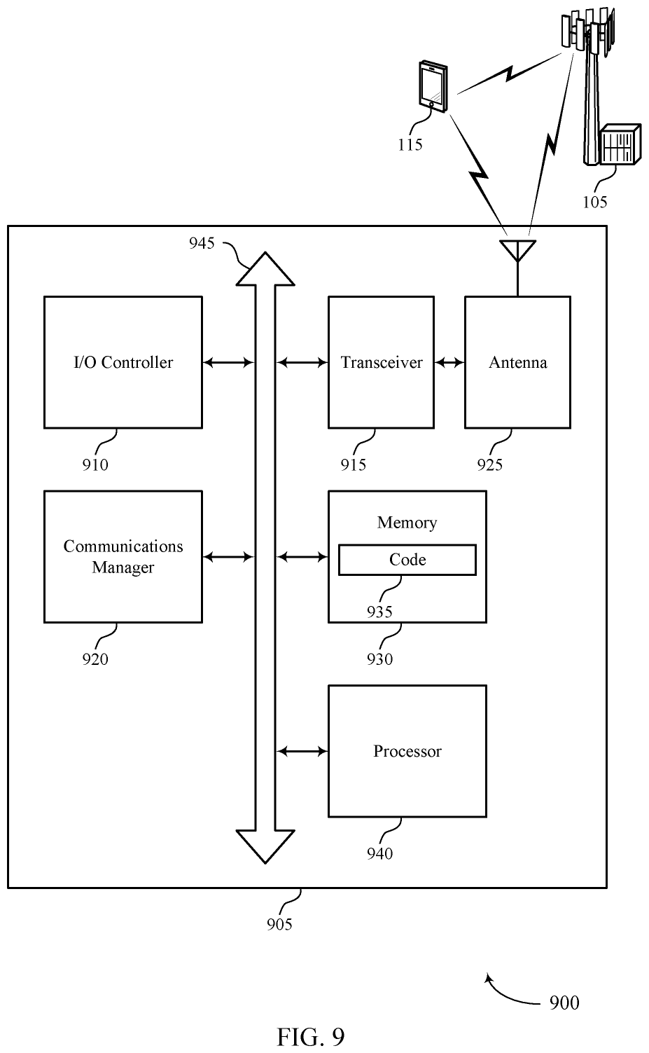

FIG. 9 shows a diagram of a system 900 including a device 905 that supports a power saving mode for satellite access in accordance with aspects of the present disclosure. The device 905 may be an example of or include the components of a device 605, a device 705, or a UE 115 as described herein. The device 905 may communicate wirelessly with one or more base stations 105, UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOSR, ANDROIDR, MS-DOSR, MS-WINDOWS®, OS/2R, UNIX®, LINUXR, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting power saving mode for satellite access). For example, the device 905 or a component of the device 905 may include a processor 940 and memory 930 coupled to the processor 940, the processor 940 and memory 930 configured to perform various functions described herein.

The communications manager 920 may support wireless communication at a UE in accordance with examples as disclosed herein. For example, the communications manager 920 may be configured as or otherwise support a means for receiving, from a network entity, control signaling including service coverage assistance information indicating a discontinuous service coverage pattern for the UE. The communications manager 920 may be configured as or otherwise support a means for determining, based on the control signaling, one or more parameters for a power saving mode of operation of the UE corresponding to the discontinuous service coverage pattern indicated in the service coverage assistance information. The communications manager 920 may be configured as or otherwise support a means for transmitting the one or more parameters for the power saving mode of operation to the network entity.

By including or configuring the communications manager 920 in accordance with examples as described herein, the device 905 may support techniques for a UE to receive coverage assistance information from a network entity, such as a satellite, that indicates a discontinuous service coverage pattern. The UE may use the discontinuous service coverage pattern to enter a power saving mode during one or more coverage gaps of the network entity, which may cause improved communication reliability, reduced latency, improved user experience related to reduced processing, reduced power consumption, more efficient utilization of communication resources, improved coordination between devices, longer battery life, improved utilization of processing capability, and the like.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of power saving mode for satellite access as described herein, or the processor 940 and the memory 930 may be otherwise configured to perform or support such operations.

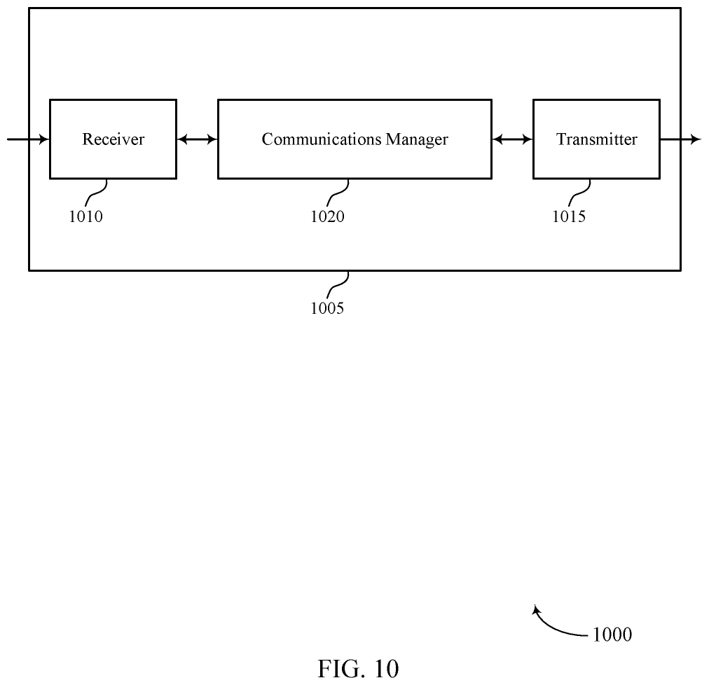

FIG. 10 shows a block diagram 1000 of a device 1005 that supports a power saving mode for satellite access in accordance with aspects of the present disclosure. The device 1005 may be an example of aspects of a network entity, such as a satellite 145 or a core network 130, as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to power saving mode for satellite access). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to power saving mode for satellite access). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of power saving mode for satellite access as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a network entity in accordance with examples as disclosed herein. For example, the communications manager 1020 may be configured as or otherwise support a means for receiving control signaling indicating that a UE is receiving discontinuous service coverage. The communications manager 1020 may be configured as or otherwise support a means for determining, based on the control signaling, one or more parameters for a power saving mode of operation of the UE corresponding to a discontinuous service coverage pattern for the UE. The communications manager 1020 may be configured as or otherwise support a means for transmitting a control message to the UE in accordance with the one or more parameters.

By including or configuring the communications manager 1020 in accordance with examples as described herein, the device 1005 (e.g., a processor controlling or otherwise coupled to the receiver 1010, the transmitter 1015, the communications manager 1020, or a combination thereof) may support techniques for a UE to receive coverage assistance information from a network entity, such as a satellite, that indicates a discontinuous service coverage pattern. The UE may use the discontinuous service coverage pattern to enter a power saving mode during one or more coverage gaps of the network entity, which may cause reduced processing, reduced power consumption, more efficient utilization of communication resources, and the like.

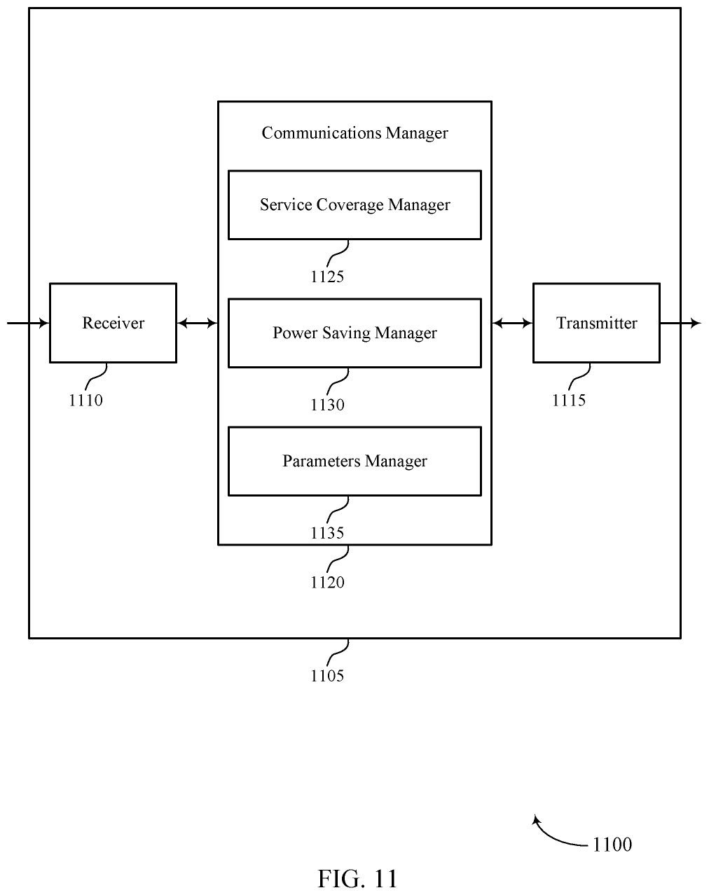

FIG. 11 shows a block diagram 1100 of a device 1105 that supports a power saving mode for satellite access in accordance with aspects of the present disclosure. The device 1105 may be an example of aspects of a device 1005 or a network entity, such as a satellite 145 or a core network 130, as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to power saving mode for satellite access). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to power saving mode for satellite access). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of power saving mode for satellite access as described herein. For example, the communications manager 1120 may include a service coverage manager 1125, a power saving manager 1130, a parameters manager 1135, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communication at a network entity in accordance with examples as disclosed herein. The service coverage manager 1125 may be configured as or otherwise support a means for receiving control signaling indicating that a UE is receiving discontinuous service coverage. The power saving manager 1130 may be configured as or otherwise support a means for determining, based on the control signaling, one or more parameters for a power saving mode of operation of the UE corresponding to a discontinuous service coverage pattern for the UE. The parameters manager 1135 may be configured as or otherwise support a means for transmitting a control message to the UE in accordance with the one or more parameters.

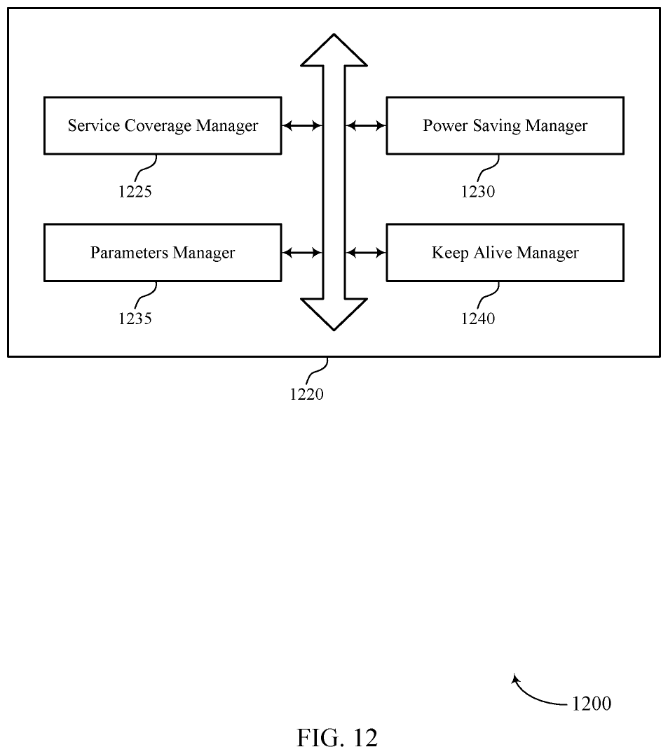

FIG. 12 shows a block diagram 1200 of a communications manager 1220 that supports a power saving mode for satellite access in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of power saving mode for satellite access as described herein. For example, the communications manager 1220 may include a service coverage manager 1225, a power saving manager 1230, a parameters manager 1235, a keep alive manager 1240, or any combination thereof. Each of these components may communicate, directly or indirectly, with one another (e.g., via one or more buses).

The communications manager 1220 may support wireless communication at a network entity in accordance with examples as disclosed herein. The service coverage manager 1225 may be configured as or otherwise support a means for receiving control signaling indicating that a UE is receiving discontinuous service coverage. The power saving manager 1230 may be configured as or otherwise support a means for determining, based on the control signaling, one or more parameters for a power saving mode of operation of the UE corresponding to a discontinuous service coverage pattern for the UE. The parameters manager 1235 may be configured as or otherwise support a means for transmitting a control message to the UE in accordance with the one or more parameters.

In some examples, to support determining the one or more parameters, the parameters manager 1235 may be configured as or otherwise support a means for receiving, from the UE or a radio access network entity, an indication of the one or more parameters.

In some examples, the parameters manager 1235 may be configured as or otherwise support a means for transmitting, to the UE, one or more additional parameters indicating an active time period, a keep alive time period, an inactive time period, or a combination thereof for the power saving mode of operation of the UE based on information indicated in the control signaling.

In some examples, the parameters manager 1235 may be configured as or otherwise support a means for transmitting the control message during an active time period indicated by the one or more parameters.

In some examples, the service coverage manager 1225 may be configured as or otherwise support a means for buffering the control message in memory during an inactive time period indicated by the one or more parameters. In some examples, the service coverage manager 1225 may be configured as or otherwise support a means for transmitting, from the memory, the control message during an active time period indicated by the one or more parameters subsequent to the buffering.

In some examples, the keep alive manager 1240 may be configured as or otherwise support a means for receiving a message from the UE during the keep alive time period indicated by the one or more parameters.

In some examples, the keep alive manager 1240 may be configured as or otherwise support a means for deregistering the UE based on expiry of the keep alive time period without receiving a message from the UE.

In some examples, to support determining the one or more parameters, the parameters manager 1235 may be configured as or otherwise support a means for determining the one or more parameters based on one or more service conditions, one or more application conditions, or both, for network access.

In some examples, the UE and the network entity are nodes in an NTN.

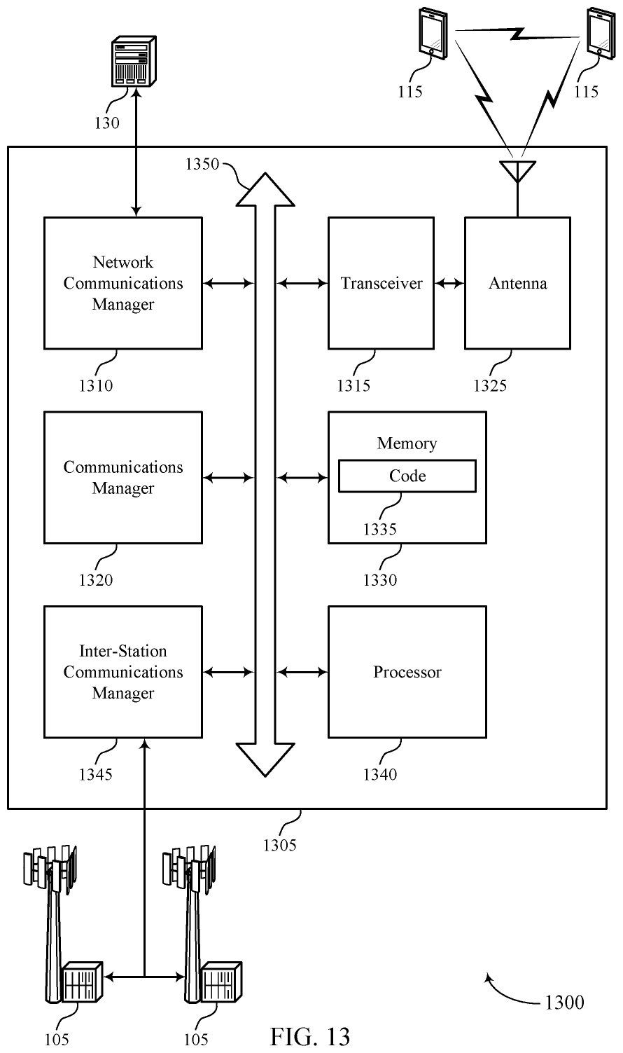

FIG. 13 shows a diagram of a system 1300 including a device 1305 that supports a power saving mode for satellite access in accordance with aspects of the present disclosure. The device 1305 may be an example of or include the components of a device 1005, a device 1105, or a network entity, such as a satellite 145 or a core network 130, as described herein. The device 1305 may include components for bi-directional voice and data communications including components for transmitting and receiving communications, such as a communications manager 1320, a network communications manager 1310, a transceiver 1315, an antenna 1325, a memory 1330, code 1335, a processor 1340, and an inter-station communications manager 1345. These components may be in electronic communication or otherwise coupled (e.g., operatively, communicatively, functionally, electronically, electrically) via one or more buses (e.g., a bus 1350).

The network communications manager 1310 may manage communications with a core network 130 (e.g., via one or more wired backhaul links). For example, the network communications manager 1310 may manage the transfer of data communications for client devices, such as one or more UEs 115.

In some cases, the device 1305 may include a single antenna 1325. However, in some other cases the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include RAM and ROM. The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a BIOS which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting power saving mode for satellite access). For example, the device 1305 or a component of the device 1305 may include a processor 1340 and memory 1330 coupled to the processor 1340, the processor 1340 and memory 1330 configured to perform various functions described herein.

The inter-station communications manager 1345 may manage communications with other base stations 105, and may include a controller or scheduler for controlling communications with UEs 115 in cooperation with other base stations 105. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communications network technology to provide communication between base stations 105.

The communications manager 1320 may support wireless communication at a network entity in accordance with examples as disclosed herein. For example, the communications manager 1320 may be configured as or otherwise support a means for receiving control signaling indicating that a UE is receiving discontinuous service coverage. The communications manager 1320 may be configured as or otherwise support a means for determining, based on the control signaling, one or more parameters for a power saving mode of operation of the UE corresponding to a discontinuous service coverage pattern for the UE. The communications manager 1320 may be configured as or otherwise support a means for transmitting a control message to the UE in accordance with the one or more parameters.

By including or configuring the communications manager 1320 in accordance with examples as described herein, the device 1305 may support techniques for a UE to receive coverage assistance information from a network entity, such as a satellite, that indicates a discontinuous service coverage pattern. The UE may use the discontinuous service coverage pattern to enter a power saving mode during one or more coverage gaps of the network entity, which may cause improved communication reliability, reduced latency, improved user experience related to reduced processing, reduced power consumption, more efficient utilization of communication resources, improved coordination between devices, longer battery life, improved utilization of processing capability, and the like.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of power saving mode for satellite access as described herein, or the processor 1340 and the memory 1330 may be otherwise configured to perform or support such operations.

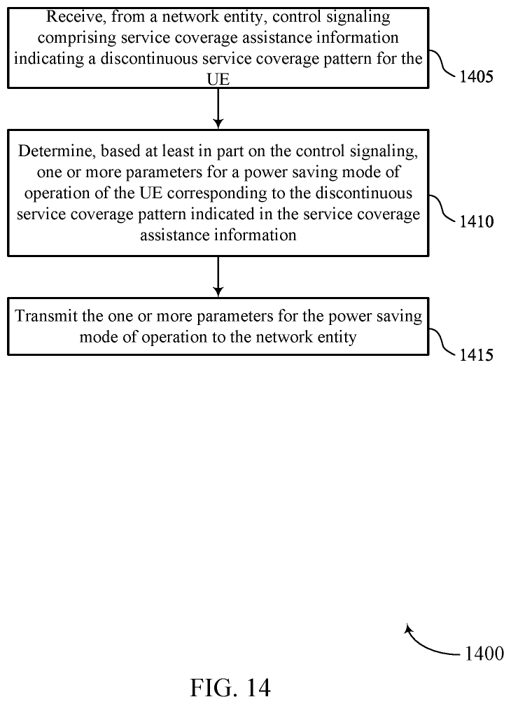

FIG. 14 shows a flowchart illustrating a method 1400 that supports a power saving mode for satellite access in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1405, the method may include receiving, from a network entity, control signaling including service coverage assistance information indicating a discontinuous service coverage pattern for the UE. The operations of 1405 may be performed in accordance with examples as disclosed herein. In some examples, aspects of the operations of 1405 may be performed by a service coverage component 825 as described with reference to FIG. 8.

At 1410, the method may include determining, based on the control signaling, one or more parameters for a power saving mode of operation of the UE corresponding to the discontinuous service coverage pattern indicated in the service coverage assistance information. The operations of 1410 may be performed in accordance with examples as disclosed herein. In some examples, aspects of the operations of 1410 may be performed by a power saving component 830 as described with reference to FIG. 8.

At 1415, the method may include transmitting the one or more parameters for the power saving mode of operation to the network entity. The operations of 1415 may be performed in accordance with examples as disclosed herein. In some examples, aspects of the operations of 1415 may be performed by a parameters component 835 as described with reference to FIG. 8.

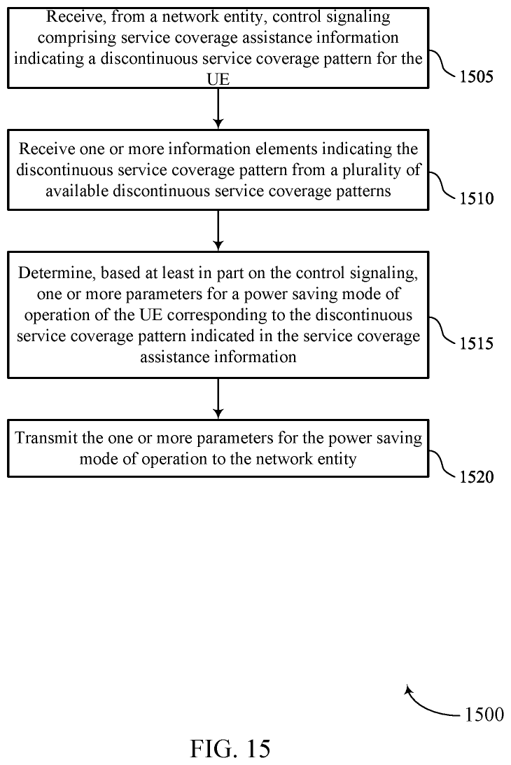

FIG. 15 shows a flowchart illustrating a method 1500 that supports a power saving mode for satellite access in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1505, the method may include receiving, from a network entity, control signaling including service coverage assistance information indicating a discontinuous service coverage pattern for the UE. The operations of 1505 may be performed in accordance with examples as disclosed herein. In some examples, aspects of the operations of 1505 may be performed by a service coverage component 825 as described with reference to FIG. 8.

At 1510, the method may include receiving one or more information elements indicating the discontinuous service coverage pattern from a set of multiple available discontinuous service coverage patterns. The operations of 1510 may be performed in accordance with examples as disclosed herein. In some examples, aspects of the operations of 1510 may be performed by a service coverage component 825 as described with reference to FIG. 8.

At 1515, the method may include determining, based on the control signaling, one or more parameters for a power saving mode of operation of the UE corresponding to the discontinuous service coverage pattern indicated in the service coverage assistance information. The operations of 1515 may be performed in accordance with examples as disclosed herein. In some examples, aspects of the operations of 1515 may be performed by a power saving component 830 as described with reference to FIG. 8.

At 1520, the method may include transmitting the one or more parameters for the power saving mode of operation to the network entity. The operations of 1520 may be performed in accordance with examples as disclosed herein. In some examples, aspects of the operations of 1520 may be performed by a parameters component 835 as described with reference to FIG. 8.

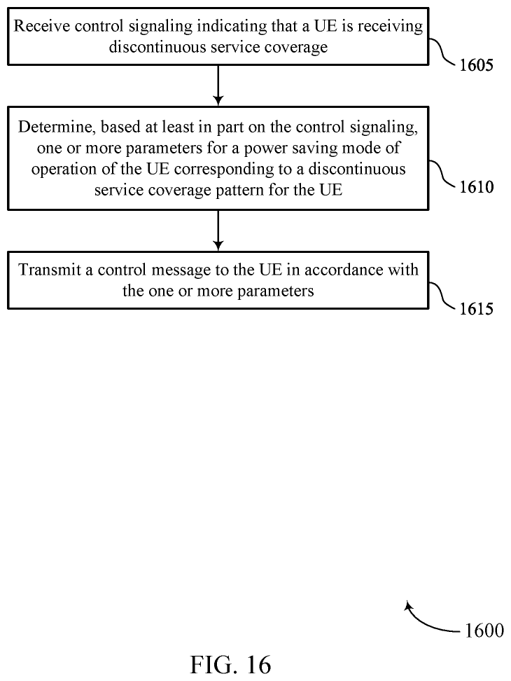

FIG. 16 shows a flowchart illustrating a method 1600 that supports a power saving mode for satellite access in accordance with aspects of the present disclosure. The operations of the method 1600 may be implemented by a network entity, such as a satellite 145 or a core network 130, or its components as described herein. For example, the operations of the method 1600 may be performed by a network entity, such as a satellite 145, or a core network 130 as described with reference to FIGS. 1 through 5 and 10 through 13. In some examples, a network entity, such as a satellite 145 or a core network 130, may execute a set of instructions to control the functional elements of the network entity to perform the described functions. Additionally or alternatively, the network entity may perform aspects of the described functions using special-purpose hardware.

At 1605, the method may include receiving control signaling indicating that a UE is receiving discontinuous service coverage. The operations of 1605 may be performed in accordance with examples as disclosed herein. In some examples, aspects of the operations of 1605 may be performed by a service coverage manager 1225 as described with reference to FIG. 12.

At 1610, the method may include determining, based on the control signaling, one or more parameters for a power saving mode of operation of the UE corresponding to a discontinuous service coverage pattern for the UE. The operations of 1610 may be performed in accordance with examples as disclosed herein. In some examples, aspects of the operations of 1610 may be performed by a power saving manager 1230 as described with reference to FIG. 12.

At 1615, the method may include transmitting a control message to the UE in accordance with the one or more parameters. The operations of 1615 may be performed in accordance with examples as disclosed herein. In some examples, aspects of the operations of 1615 may be performed by a parameters manager 1235 as described with reference to FIG. 12.

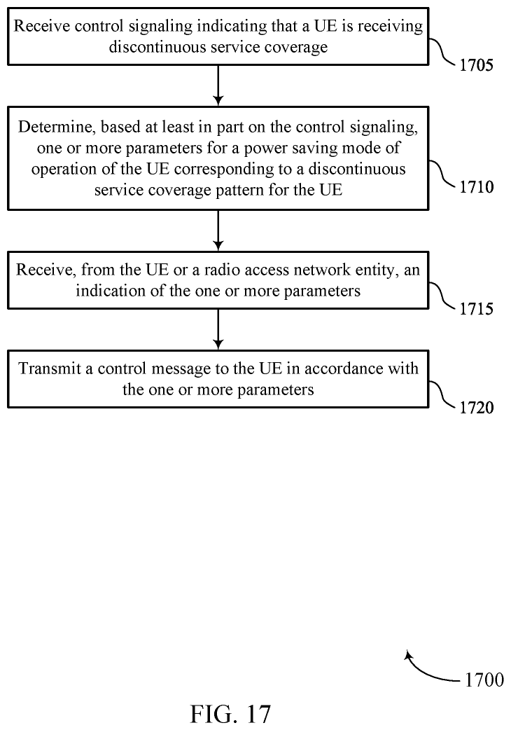

FIG. 17 shows a flowchart illustrating a method 1700 that supports a power saving mode for satellite access in accordance with aspects of the present disclosure. The operations of the method 1700 may be implemented by a network entity, such as a satellite 145 or a core network 130, or its components as described herein. For example, the operations of the method 1700 may be performed by a network entity, such as a satellite 145 or a core network 130, as described with reference to FIGS. 1 through 5 and 10 through 13. In some examples, a network entity, such as a satellite 145 or a core network 130, may execute a set of instructions to control the functional elements of the network entity to perform the described functions. Additionally or alternatively, the network entity may perform aspects of the described functions using special-purpose hardware.

At 1705, the method may include receiving control signaling indicating that a UE is receiving discontinuous service coverage. The operations of 1705 may be performed in accordance with examples as disclosed herein. In some examples, aspects of the operations of 1705 may be performed by a service coverage manager 1225 as described with reference to FIG. 12.

At 1710, the method may include determining, based on the control signaling, one or more parameters for a power saving mode of operation of the UE corresponding to a discontinuous service coverage pattern for the UE. The operations of 1710 may be performed in accordance with examples as disclosed herein. In some examples, aspects of the operations of 1710 may be performed by a power saving manager 1230 as described with reference to FIG. 12.

At 1715, the method may include receiving, from the UE or a radio access network entity, an indication of the one or more parameters. The operations of 1715 may be performed in accordance with examples as disclosed herein. In some examples, aspects of the operations of 1715 may be performed by a parameters manager 1235 as described with reference to FIG. 12.

At 1720, the method may include transmitting a control message to the UE in accordance with the one or more parameters. The operations of 1720 may be performed in accordance with examples as disclosed herein. In some examples, aspects of the operations of 1720 may be performed by a parameters manager 1235 as described with reference to FIG. 12.

The following provides an overview of aspects of the present disclosure:

Aspect 1: A method for wireless communication at a UE, comprising: receiving, from a network entity, control signaling comprising service coverage assistance information indicating a discontinuous service coverage pattern for the UE; determining, based at least in part on the control signaling, one or more parameters for a power saving mode of operation of the UE corresponding to the discontinuous service coverage pattern indicated in the service coverage assistance information: and transmitting the one or more parameters for the power saving mode of operation to the network entity.

Aspect 2: The method of aspect 1, wherein receiving the control signaling comprises: receiving one or more information elements indicating the discontinuous service coverage pattern from a plurality of available discontinuous service coverage patterns.

Aspect 3: The method of aspect 2 wherein the one or more information elements are included in system information on a broadcast channel of a serving radio cell.

Aspect 4: The method of any of aspects 1 through 3 wherein transmitting the one or more parameters comprises: transmitting the one or more parameters indicating an active time period, a keep alive time period, an inactive time period, or a combination thereof for the power saving mode of operation of the UE based at least in part on the discontinuous service coverage pattern.

Aspect 5: The method of any of aspects 1 through 4 wherein transmitting the one or more parameters comprises: transmitting a registration update request message comprising the one or more parameters during an in coverage time period corresponding to the discontinuous service coverage pattern.

Aspect 6: The method of any of aspects 1 through 5, further comprising: transmitting, to the network entity, a message during a keep alive time period in accordance with the one or more parameters.

Aspect 7: The method of any of aspects 1 through 6, further comprising: determining the discontinuous service coverage pattern based at least in part on the service coverage assistance information.

Aspect 8: The method of aspect 7, wherein the service coverage assistance information comprises ephemeris data.

Aspect 9: The method of any of aspects 7 through 8, wherein the service coverage assistance information comprises a duration of radio cell coverage and a duration of a coverage gap.

Aspect 10: The method of any of aspects 1 through 9, further comprising: monitoring for one or more paging messages from the network entity during an active time period indicated by the one or more parameters.

Aspect 11: The method of any of aspects 1 through 10, further comprising: receiving, from the network entity, one or more additional parameters indicating an active time period, a keep alive time period, an inactive time period, or a combination thereof for the power saving mode of operation of the UE based at least in part on the one or more parameters.

Aspect 12: The method of aspect 11, further comprising: starting the inactive time period upon expiry of the active time period indicated by the one or more additional parameters: and entering the power saving mode of operation during the inactive time period.

Aspect 13: The method of aspect 12, further comprising: exiting the power saving mode of operation upon expiry of the inactive time period.

Aspect 14: The method of any of aspects 11 through 13, wherein a duration of the inactive time period is indicated by the one or more additional parameters.

Aspect 15: The method of any of aspects 11 through 13, wherein a duration of the inactive time period is determined based at least in part on one or more network access conditions of one or more applications.

Aspect 16: The method of any of aspects 1 through 15 wherein transmitting the one or more parameters comprises: transmitting an indication that the one or more parameters are valid for a plurality of time durations.

Aspect 17: The method of any of aspects 1 through 16, wherein determining the one or more parameters comprises: determining the one or more parameters based at least in part on one or more service conditions, one or more application conditions, or both, for network access.

Aspect 18: The method of any of aspects 1 through 17 wherein the UE and the network entity are nodes in a non-terrestrial network.

Aspect 19: A method for wireless communication at a network entity, comprising: receiving control signaling indicating that a UE is receiving discontinuous service coverage: determining, based at least in part on the control signaling, one or more parameters for a power saving mode of operation of the UE corresponding to a discontinuous service coverage pattern for the UE: and transmitting a control message to the UE in accordance with the one or more parameters.

Aspect 20: The method of aspect 19, wherein determining the one or more parameters comprises: receiving, from the UE or a radio access network entity, an indication of the one or more parameters.

Aspect 21: The method of any of aspects 19 through 20, further comprising: transmitting, to the UE, one or more additional parameters indicating an active time period, a keep alive time period, an inactive time period, or a combination thereof for the power saving mode of operation of the UE based at least in part on information indicated in the control signaling.

Aspect 22: The method of any of aspects 19 through 21, further comprising: transmitting the control message during an active time period indicated by the one or more parameters.

Aspect 23: The method of any of aspects 19 through 22, further comprising: buffering the control message in memory during an inactive time period indicated by the one or more parameters: and transmitting, from the memory, the control message during an active time period indicated by the one or more parameters subsequent to the buffering.

Aspect 24: The method of any of aspects 19 through 23, further comprising: receiving a message from the UE during the keep alive time period indicated by the one or more parameters.

Aspect 25: The method of any of aspects 19 through 23, further comprising: deregistering the UE based at least in part on expiry of the keep alive time period without receiving a message from the UE.

Aspect 26: The method of any of aspects 19 through 25, wherein determining the one or more parameters comprises: determining the one or more parameters based at least in part on one or more service conditions, one or more application conditions, or both, for network access.

Aspect 27: The method of any of aspects 19 through 26 wherein the UE and the network entity are nodes in a non-terrestrial network.

Aspect 28: An apparatus for wireless communication at a UE, comprising a processor: memory coupled with the processor; and instructions stored in the memory and executable by the processor to cause the apparatus to perform a method of any of aspects 1 through 18.

Aspect 29: An apparatus for wireless communication at a UE, comprising at least one means for performing a method of any of aspects 1 through 18.

Aspect 30: A non-transitory computer-readable medium storing code for wireless communication at a UE, the code comprising instructions executable by a processor to perform a method of any of aspects 1 through 18.

Aspect 31: An apparatus for wireless communication at a network entity, comprising a processor: memory coupled with the processor: and instructions stored in the memory and executable by the processor to cause the apparatus to perform a method of any of aspects 19 through 27.

Aspect 32: An apparatus for wireless communication at a network entity, comprising at least one means for performing a method of any of aspects 19 through 27.

Aspect 33: A non-transitory computer-readable medium storing code for wireless communication at a network entity, the code comprising instructions executable by a processor to perform a method of any of aspects 19 through 27.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving, from a network entity, control signaling comprising service coverage assistance information indicating a discontinuous service coverage pattern for the UE;
determining, based at least in part on the control signaling, one or more parameters for a power saving mode of operation of the UE corresponding to the discontinuous service coverage pattern indicated in the service coverage assistance information; and
transmitting the one or more parameters for the power saving mode of operation to the network entity.

2. The method of claim 1, wherein receiving the control signaling comprises:
receiving one or more information elements indicating the discontinuous service coverage pattern from a plurality of available discontinuous service coverage patterns.

3. The method of claim 2 wherein the one or more information elements are included in system information on a broadcast channel of a serving radio cell.

4. The method of claim 1 wherein transmitting the one or more parameters comprises:
transmitting the one or more parameters indicating an active time period, a keep alive time period, an inactive time period, or a combination thereof for the power saving mode of operation of the UE based at least in part on the discontinuous service coverage pattern.

5. The method of claim 1 wherein transmitting the one or more parameters comprises:
transmitting a registration update request message comprising the one or more parameters during an in coverage time period corresponding to the discontinuous service coverage pattern.

6. The method of claim 1, further comprising:
transmitting, to the network entity, a message during a keep alive time period in accordance with the one or more parameters.

7. The method of claim 1, further comprising:
determining the discontinuous service coverage pattern based at least in part on the service coverage assistance information.

8. The method of claim 7, wherein the service coverage assistance information comprises ephemeris data.

9. The method of claim 7, wherein the service coverage assistance information comprises a duration of radio cell coverage and a duration of a coverage gap.

10. The method of claim 1, further comprising:
monitoring for one or more paging messages from the network entity during an active time period indicated by the one or more parameters.

11. The method of claim 1, further comprising:
receiving, from the network entity, one or more additional parameters indicating an active time period, a keep alive time period, an inactive time period, or a combination thereof for the power saving mode of operation of the UE based at least in part on the one or more parameters.

12. The method of claim 11, further comprising:
starting the inactive time period upon expiry of the active time period indicated by the one or more additional parameters; and
entering the power saving mode of operation during the inactive time period.

13. The method of claim 12, further comprising:
exiting the power saving mode of operation upon expiry of the inactive time period.

14. The method of claim 11, wherein a duration of the inactive time period is indicated by the one or more additional parameters.

15. The method of claim 11, wherein a duration of the inactive time period is determined based at least in part on one or more network access conditions of one or more applications.

16. The method of claim 1 wherein transmitting the one or more parameters comprises:
transmitting an indication that the one or more parameters are valid for a plurality of time durations.

17. The method of claim 1, wherein determining the one or more parameters comprises:
determining the one or more parameters based at least in part on one or more service conditions, one or more application conditions, or both, for network access.

18. The method of claim 1 wherein the UE and the network entity are nodes in a non-terrestrial network.

19. A method for wireless communication at a network entity, comprising:
receiving control signaling indicating that a user equipment (UE) is receiving discontinuous service coverage;
determining, based at least in part on the control signaling, one or more parameters for a power saving mode of operation of the UE corresponding to a discontinuous service coverage pattern for the UE; and
transmitting a control message to the UE in accordance with the one or more parameters.

20. The method of claim 19, wherein determining the one or more parameters comprises:
receiving, from the UE or a radio access network entity, an indication of the one or more parameters.

21. The method of claim 19, further comprising:
transmitting, to the UE, one or more additional parameters indicating an active time period, a keep alive time period, an inactive time period, or a combination thereof for the power saving mode of operation of the UE based at least in part on information indicated in the control signaling.

22. The method of claim 19, further comprising:
transmitting the control message during an active time period indicated by the one or more parameters.

23. The method of claim 19, further comprising:
buffering the control message in memory during an inactive time period indicated by the one or more parameters; and
transmitting, from the memory, the control message during an active time period indicated by the one or more parameters subsequent to the buffering.

24. The method of claim 19, further comprising:
receiving a message from the UE during the keep alive time period indicated by the one or more parameters.

25. The method of claim 19, further comprising:
deregistering the UE based at least in part on expiry of the keep alive time period without receiving a message from the UE.

26. The method of claim 19, wherein determining the one or more parameters comprises:
determining the one or more parameters based at least in part on one or more service conditions, one or more application conditions, or both, for network access.

27. The method of claim 19 wherein the UE and the network entity are nodes in a non-terrestrial network.

28. An apparatus for wireless communication at a user equipment (UE), comprising:
a processor;
memory coupled with the processor; and
instructions stored in the memory and executable by the processor to cause the apparatus to:
receive, from a network entity, control signaling comprising service coverage assistance information indicating a discontinuous service coverage pattern for the UE;
determine, based at least in part on the control signaling, one or more parameters for a power saving mode of operation of the UE corresponding to the discontinuous service coverage pattern indicated in the service coverage assistance information; and
transmit the one or more parameters for the power saving mode of operation to the network entity.

29. The apparatus of claim 28, wherein the instructions to receive the control signaling are executable by the processor to cause the apparatus to:
receive one or more information elements indicating the discontinuous service coverage pattern from a plurality of available discontinuous service coverage patterns.

30. An apparatus for wireless communication at a network entity, comprising:
a processor;
memory coupled with the processor; and
instructions stored in the memory and executable by the processor to cause the apparatus to:
receive control signaling indicating that a user equipment (UE) is receiving discontinuous service coverage;
determine, based at least in part on the control signaling, one or more parameters for a power saving mode of operation of the UE corresponding to a discontinuous service coverage pattern for the UE; and
transmit a control message to the UE in accordance with the one or more parameters.
